(19) United States
(12) Patent Application Publication
(10) Pub. No.: US 2024/0388538 A1
(43) Pub. Date: Nov. 21, 2024

(54) PACKET TRANSMISSION METHOD, COMMUNICATION DEVICE, STORAGE MEDIUM, AND PROGRAM PRODUCT

(71) Applicant: Tencent Technology (Shenzhen) Company Limited, Shenzhen (CN)

(72) Inventor: Zhuoyun ZHANG, Shenzhen (CN)

(73) Assignee: Tencent Technology (Shenzhen) Company Limited, Shenzhen (CN)

(21) Appl. No.: 18/790,279

(22) Filed: Jul. 31, 2024

Related U.S. Application Data
(63) Continuation of application No. PCT/CN2022/142209, filed on Dec. 27, 2022.

(30) Foreign Application Priority Data
May 6, 2022 (CN) 202210485758.3

(51) Int. Cl. H04L 47/2408; H04L 47/20; H04L 47/32

(52) U.S. Cl. CPC H04L 47/2408; H04L 47/20; H04L 47/32

(57) ABSTRACT

A packet transmission method, performed by a communication device, includes: obtaining quality of service (QOS) profile information of a target service stream from a session management object (SMO); receiving a first packet to be forwarded; and processing the first packet according to a detection rule of the QoS profile information and a processing rule of the QoS profile information, wherein the detection rule includes second dependency information of a second packet of a core network.

### CROSS-REFERENCE TO RELATED APPLICATIONS

This application is a continuation application of International Application No. PCT/CN2022/142209 filed on Dec. 27, 2022, which claims priority to Chinese Patent Application No. 202210485758.3 filed with the China National Intellectual Property Administration on May 6, 2022, the disclosures of each being incorporated by reference herein in their entireties.

### FIELD

The disclosure relates to the field of communications technologies, and specifically, to a packet transmission method, a communication device, a storage medium, and a program product.

### BACKGROUND

In a process of transmitting a packet over a network, the packet may need to be processed to adapt to a network transmission status, but an adequate manner of determining how to process the packet to minimize a deterioration of service experience of a service has not been provided in related technologies.

### SUMMARY

Provided are a packet transmission method, a communication device, a storage medium, and a program product, to optimize a packet transmission process.

According to some embodiments, a packet transmission method, performed by a communication device, includes: obtaining quality of service (QOS) profile information of a target service stream from a session management object (SMO); receiving a first packet to be forwarded; and processing the first packet according to a detection rule of the QoS profile information and a processing rule of the QoS profile information, wherein the detection rule includes second dependency information of a second packet of a core network.

According to some embodiments, a communication device includes: at least one memory configured to store computer program code; at least one processor configured to read the program code and operate as instructed by the program code, the program code including: obtaining code configured to cause at least one of the at least one processor to obtain quality of service (QOS) profile information of a target service stream from a session management object (SMO); receiving code configured to cause at least one of the at least one processor to receive a first packet to be forwarded; and processing code configured to cause at least one of the at least one processor to process the first packet according to a detection rule of the QoS profile information and a processing rule of the QoS profile information, wherein the detection rule includes second dependency information of a second packet of a core network.

According to some embodiments, a non-transitory computer readable storage medium, storing computer code which, when executed by at least one processor, causes the at least one processor to at least: obtain quality of service (QOS) profile information of a target service stream from a session management object (SMO); receive a first packet to be forwarded; and process the first packet according to a detection rule of the QoS profile information and a processing rule of the QoS profile information, wherein the detection rule includes second dependency information of a second packet of a core network.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a communication system architecture according to some embodiments.

FIG. 2 is a system architecture diagram of a 5G network according to some embodiments.

FIG. 3 is a flowchart of a packet transmission method according to some embodiments.

FIG. 4 is a schematic diagram of interaction of a packet transmission method according to some embodiments.

FIG. 5 is a schematic diagram of interaction of a packet transmission method according to some embodiments.

FIG. 6 is a schematic diagram of interaction of a packet transmission method according to some embodiments.

FIG. 7 is a schematic diagram of interaction of a packet transmission method according to some embodiments.

FIG. 8 is a flowchart of a packet transmission method according to some embodiments.

FIG. 9 is a flowchart of a packet transmission method according to some embodiments.

FIG. 10 is a flowchart of a packet transmission method according to some embodiments.

FIG. 11 is a flowchart of a packet transmission method according to some embodiments.

FIG. 12 is a schematic diagram of interaction of a packet transmission method according to some embodiments.

FIG. 13 is a schematic diagram of interaction of a packet transmission method according to some embodiments.

FIG. 14 is a schematic diagram of interaction of a packet transmission method according to some embodiments.

FIG. 15 is a schematic diagram of interaction of a packet transmission method according to some embodiments.

FIG. 16 is a flowchart of a packet transmission method according to some embodiments.

FIG. 17 is a flowchart of a packet transmission method according to some embodiments.

FIG. 18 is a flowchart of a packet transmission method according to some embodiments.

FIG. 19 is a flowchart of a packet transmission method according to some embodiments.

FIG. 20 is a schematic diagram of interaction of a packet transmission method according to some embodiments.

FIG. 21 is a schematic structural diagram of a communication device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The technical solutions in some embodiments may be applied to various communication systems, such as a Global System for Mobile Communications (GSM) system, a Code Division Multiple Access (CDMA) system, a Wideband Code Division Multiple Access (WCDMA) system, a general packet radio service (GPRS), a Long Term Evolution (LTE) system, an LTE frequency division duplex (FDD) system, an LTE time division duplex (TDD) system, a Universal Mobile Telecommunications System (UMTS), and a Worldwide Interoperability for Microwave Access (WiMAX) communication system, a 5G system, or a future evolved mobile communication system.

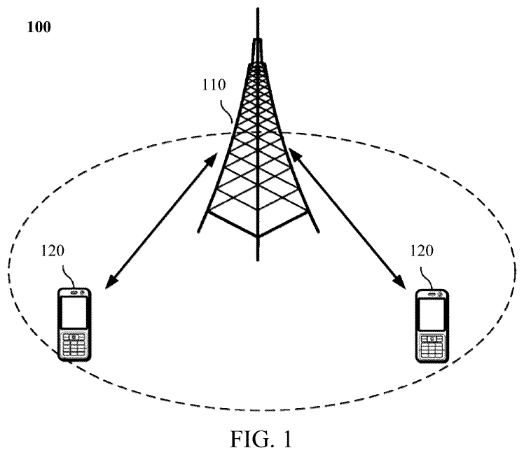

For example, a communication system 100 according to some embodiments is shown in FIG. 1. The communication system 100 may include a network device 110, and the network device 110 may be a device communicating with a terminal 120 (or referred to as a communication terminal or a terminal). The network device 110 may provide communication coverage for a geographic area, and may communicate with a terminal located inside the covered area. In some embodiments, the network device 110 may be a base transceiver station (BTS) in a GSM system or a CDMA system, a NodeB (NB) in a WCDMA system, an evolved NodeB (eNB or eNodeB) in an LTE system, a base station in a 5G communication system, or a wireless controller in a cloud radio access network (CRAN). Alternatively, the network device may be a network side device in a mobile switching center, a relay station, an access point, an in-vehicle device, a wearable device, a hub, a switch, a bridge, a router, or a 5G network, or may be a network device or the like in a future evolved public land mobile network (PLMN).

The communication system 100 further includes at least one terminal device 120 located within the coverage range of the network device 110. The “terminal” used herein includes, but is not limited to: being connected through a wired line, for example, through a public switched telephone network (PSTN), a digital subscriber line (DSL), a digital cable, or a direct cable; and/or another data connection/network; and/or being connected through a wireless interface, for example, through a cellular network, a wireless local area network (WLAN), a digital television network such as a DVB-H network, a satellite network, or an AM-FM broadcast transmitter; and/or an apparatus of another terminal that may be configured to receive/send communication signals; and/or an Internet of Things (IoT) device. The terminal that may be configured to communicate through the wireless interface may be referred to as a “wireless communication terminal”, a “wireless terminal”, or a “mobile terminal”. An example of the mobile terminal includes, but is not limited to, a satellite or a cellular phone; a personal communications system (PCS) terminal that combines a cellular radio telephone, data processing, fax, and data communication capabilities; and may be a PDA including a radio telephone, a beeper, Internet/Intranet access, a web browser, a memo pad, a calendar, and/or a global positioning system (GPS) receiver; and may be a laptop and/or palmtop receiver or another electronic apparatus including a radio telephone transceiver. The terminal may be an access terminal, user equipment (UE), a subscriber unit, a subscriber station, a mobile station, a mobile console, a remote station, a remote terminal, a mobile device, a user terminal, a terminal, a wireless communication device, a user agent, or a user apparatus. The access terminal may be a cellular phone, a cordless phone, a Session Initiation Protocol (SIP) phone, a wireless local loop (WLL) station, a personal digital assistant (PDA), a handheld device having a wireless communication function, a computing device, another processing device connected to a wireless modem, an in-vehicle device, a wearable device, a terminal in a 5G network, a terminal in a future evolved PLMN or the like.

In some embodiments, the terminals 120 may perform device to device (D2D) communication with each other.

FIG. 1 shows one network device and two terminals as an example. In some embodiments, the communication system 100 may include a plurality of network devices, and in a coverage area of each network device, another quantity of terminals may be included. However, the disclosure is not limited thereto.

In some embodiments, the communication system 100 may further include a PCO (sometimes referred to as a “policy control function” (PCF) by the 3rd Generation Partnership Project (3GPP), for example), an access and mobility management object (AMO) (sometimes referred to as an “access and mobility management function” (AMF) by the 3GPP, for example), and other network elements. However, the disclosure is not limited thereto.

In a network/system in some embodiments, a device having a communication function may be referred to as a communication device. Using the communication system 100 shown in FIG. 1 as an example, the communication device may include a network device 110 and a terminal 120 that have a communication function. The network device 110 and the terminal 120 may be devices described above.

The terms “system” and “network” are may be interchangeably used. The term “and/or” describes an association relationship for describing associated objects and represents that three relationships may exist. For example, A and/or B may represent the following three cases: Only A exists, both A and B exist, and only B exists.

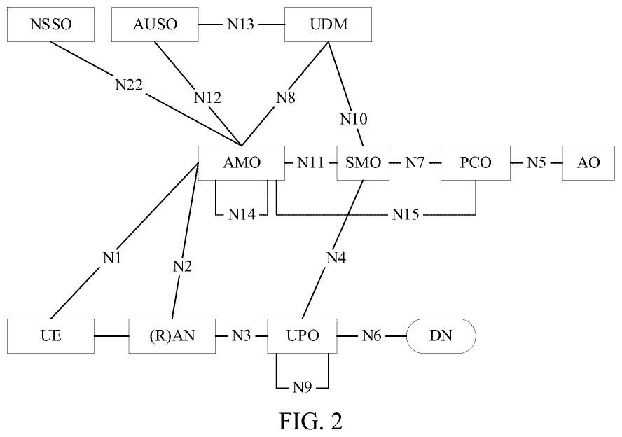

FIG. 2 is a system architecture diagram of a 5G network according to some embodiments. As shown in FIG. 2, devices involved in the 5G network system include: a terminal (UE), a radio access network (RAN), a user plane object (UPO) (sometimes referred to as a “user plane function” (UPF) by the 3GPP, for example), a data network (DN), a mobility management object (AMO) (sometimes referred to as a “mobility management function” (AMF) by the 3GPP, for example), a session management object (SMO) (sometimes referred to as a “session management function” (SMF) by the 3GPP, for example), a PCO (such as a such as a “policy control function” (PCF) by the 3GPP, for example), an application object (AO) (sometimes referred to as an “application function” (AF) by the 3GPP, for example), an authentication server object (AUSO) (sometimes referred to as an “authentication server function” (AUSF) by the 3GPP, for example), and a unified data management (UDM).

A person skilled in the art would understand these objects could be implemented by hardware logic, a processor or processors executing computer software code, or a combination of both. The objects may also be implemented in software stored in a memory of a computer or a non-transitory computer-readable medium, where the instructions of each module and unit are executable by a processor to thereby cause the processor to perform the respective operations of the corresponding object.

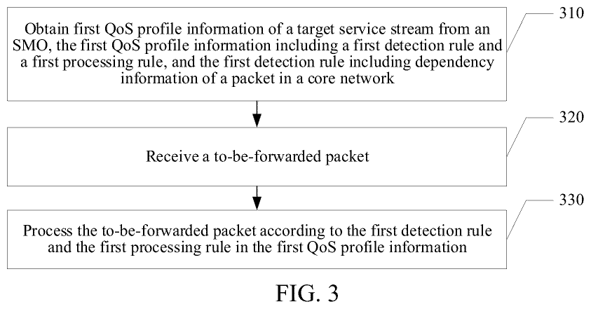

FIG. 3 is a flowchart of a packet transmission method according to some embodiments. The method as illustrated in FIG. 3 may be performed by a network device (for example, base station), and a network device in some embodiments may be, for example, the network device 110 in FIG. 1, but the disclosure is not limited thereto. Any communication device that may detect and process a packet may use the method according to some embodiments.

As shown in FIG. 3, the method according to some embodiments may include:

310: Obtain first QoS profile information of a target service stream from an SMO, and the first QoS profile information may include a first detection rule and a first processing rule, and the first detection rule may include dependency information of a packet in a core network.

In some embodiments, the base station may receive the first QoS (Quality of Service) profile information of the target service stream from the SMO, and the first QoS profile information may include the first detection rule and the first processing rule.

In some embodiments, the first detection rule may include the dependency information of the packet in the core network. The dependency information of the packet in the core network refers to identification information that is determined by a network (for example, a PCO in the core network) and that is configured for indicating whether interdependency exists between different packets. This interdependency may be set according to an actual scenario, for example, whether another packet may be correctly decoded and/or correctly received in dependence on the to-be-forwarded packet.

In some embodiments, dependency information of a packet in the core network may be configured for indicating whether the to-be-forwarded packet is depended on by another packet and/or whether the to-be-forwarded packet depends on another packet. In each of the following exemplary descriptions, that dependency information of a packet in the core network is configured for indicating whether the to-be-forwarded packet is depended on by another packet is used as an example, but the disclosure is not limited thereto.

In some embodiments, whether there is a close dependence relationship between different packets may be determined according to a configuration of an actual scenario. For example, if encoded image or video data is transmitted in a packet, whether there is a close dependence relationship between different packets may be determined according to whether reference is to be made to another packet to decode the encoded image or video packet based on a client side (which may correspond to a terminal side) or a service server side receiving the encoded image or video packet. Different packets with a referring or referred relationship during decoding may be considered as having a close dependence relationship. Different packets with no referring or referred relationship during decoding may be considered as having no close dependence relationship.

For example, “1” may be used for indicating the to-be-forwarded packet is depended on by another packet, and “0” may be used for indicating the to-be-forwarded packet is not depended on by another packet, for example, no other packet is to be decoded and/or received in dependence on the to-be-forwarded packet.

In some embodiments, the target service stream refers to a service stream formed by transmitting, in a network, an uplink packet sent by a terminal and/or a downlink packet sent by a service server for one or some target services, and the target service may be set according to an actual use. For example, the target service may be a multimedia service, but the disclosure is not limited thereto.

320: Receive a to-be-forwarded packet.

In some embodiments, the to-be-forwarded packet may include an uplink packet sent by the terminal and received by the network device, and/or may include a downlink packet sent by the service server and received by the network device.

330: Process the to-be-forwarded packet according to the first detection rule and the first processing rule in the first QoS profile information.

In some embodiments, the processing the to-be-forwarded packet according to the first detection rule and the first processing rule in the first QoS profile information may include: based on congestion occurring in a network, transmitting the to-be-forwarded packet according to the first processing rule if it is determined that dependency information of the to-be-forwarded packet satisfies the first detection rule; or discarding the to-be-forwarded packet according to the first processing rule if dependency information of the to-be-forwarded packet does not satisfy the first detection rule.

In some embodiments, the base station may detect the received to-be-forwarded packet, to determine whether the received to-be-forwarded packet belongs to packets of the target service stream (including an uplink packet and a downlink packet), and based on determining that the received to-be-forwarded packet belongs to the packets of the target service stream, detect, by using the first detection rule, whether the dependency information of the to-be-forwarded packet matches dependency information of a packet in the core network in the first detection rule.

The determining that the dependency information of the to-be-forwarded packet matches dependency information of a packet in the core network in the first detection rule indicates that the to-be-forwarded packet includes the dependency information of the packet in the core network and the dependency information of the packet in the core network included in the to-be-forwarded packet is the same as the dependency information of the packet in the core network in the first detection rule.

The determining that the dependency information of the to-be-forwarded packet does not match dependency information of a packet in the core network in the first detection rule indicates that the to-be-forwarded packet does not include the dependency information of the packet in the core network; or that although the to-be-forwarded packet includes the dependency information of the packet in the core network, the dependency information of the packet in the core network included in the to-be-forwarded packet is different from the dependency information of the packet in the core network in the first detection rule.

In some embodiments, the first processing rule may be configured for instructing the network device, based on congestion occurring in a network, to transmit the to-be-forwarded packet if it is detected that the dependency information of the to-be-forwarded packet satisfies the first detection rule, and discard another packet that does not satisfy the first detection rule; or discard the to-be-forwarded packet compared with another packet satisfying the first packet detection rule if the network device detects that the dependency information of the to-be-forwarded packet does not satisfy the first detection rule.

For different packets with a close dependence relationship, if the to-be-forwarded packet depended on by another packet is lost for a reason such as congestion, it is possible that decoding of an image or a video corresponding to the another packet in dependence on the to-be-forwarded packet cannot be completed on the client side or server side. In some embodiments, the dependency information of the packet in the core network is set in the first detection rule, and is configured for detecting whether the received to-be-forwarded packet is depended on by another packet. If the to-be-forwarded packet is depended on by another packet, the to-be-forwarded packet is transmitted according to the first data processing rule, thereby ensuring that the another packet in dependence on the to-be-forwarded packet may be correctly received and/or decoded, reducing impact on decoding on the client or server side, and ensuring service experience of a target service such as a multimedia service as much as possible. In some embodiments, the to-be-forwarded packet that is not depended on by another packet may be further discarded through the first detection rule and the first processing rule based on congestion occurring in a network, thereby alleviating a network congestion status, reducing occupied transmission resources, and optimizing packet network transmission.

The first detection rule and the first processing rule may be merged into the same rule, or may be divided into different rules, or may be used as a part of another rule, or may be used as a part of a QoS profile. According to different execution entities, the rule may have different names. This is not limited.

In some embodiments, the first detection rule may further include an uplink/downlink validity indication, and the uplink/downlink validity indication may be configured for indicating whether the first detection rule is valid for an uplink packet, or valid for a downlink packet, or valid for both an uplink packet and a downlink packet.

In some embodiments, the network device may determine whether the first detection rule is valid for an uplink service stream, a downlink service stream, or an uplink service stream and a downlink service stream of the target service stream according to the uplink/downlink validity indication; and process, if it is determined that the first detection rule is valid for a downlink service stream, the to-be-forwarded packet according to the first detection rule and the first processing rule in the first QoS profile information based on determining that the to-be-forwarded packet belongs to the downlink service stream of the target service stream; process, if it is determined that the first detection rule is valid for an uplink service stream, the to-be-forwarded packet according to the first detection rule and the first processing rule in the first QoS profile information based on determining that the to-be-forwarded packet belongs to the uplink service stream of the target service stream; or separately detect, if it is determined that the first detection rule is valid for an uplink service stream and a downlink service stream, the uplink service stream and the downlink service stream of the target service stream, and process the to-be-forwarded packet according to the first detection rule and the first processing rule in the first QoS profile information.

Through the uplink/downlink validity indication, network transmission of the packet of the target service stream may be detected and processed more accurately.

In the packet transmission method according to some embodiments, a network device obtains first QoS profile information of a target service stream from an SMO, the first QoS profile information including a first detection rule and a first processing rule, and the first detection rule carrying dependency information of a packet in a core network, so that based on receiving a to-be-forwarded packet, the network device may determine, according to the first detection rule and the first processing rule in the first QoS profile information, how to process the to-be-forwarded packet, to optimize a network transmission process of the to-be-forwarded packet.

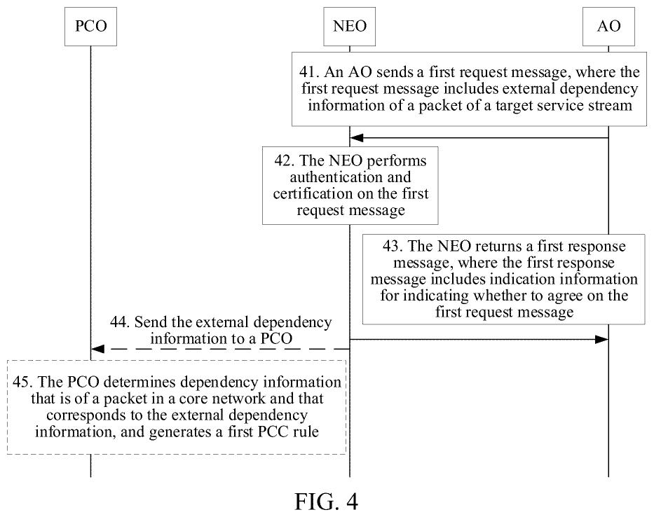

According to some embodiments, FIG. 4 shows a schematic diagram of an AO interaction service requirement based on packets not being grouped. As shown in FIG. 4, the method provided in some embodiments may include:

41: An AO sends a first request message to a network exposure object (NEO) (sometimes referred to as a “network exposure function” (NEF) by the 3GPP, for example), and the first request message may include external dependency information of a packet of a target service stream.

In some embodiments, the first request message may include association information of the packet, to determine whether the packet may be discarded or continue to be transmitted in network transmission.

For example, the association information of the packet may include the external dependency information of the packet of the target service stream. The AO may determine the external dependency information of the packet of the target service stream.

In some embodiments, the external dependency information of the packet of the target service stream refers to identification information that is determined by the AO or the NEO and that is configured for indicating whether interdependency exists between different packets. This interdependency may be set according to an actual scenario, for example, interdependency of the to-be-forwarded packet is set according to whether another packet may be correctly decoded and/or correctly received in dependence on the to-be-forwarded packet. The external dependency information is not configured for distinguishing between intra-group dependence and inter-group dependence, but is configured for identifying whether dependence between packets exists.

In some embodiments, the first request message may be further configured for identifying one or more packets that depend on the packet.

In some embodiments, the first request message sent by the AO to the NEO may further include at least one of AO identification information (represented with AO ID), target service stream template information, target data network name (DNN) information and/or target single-network slice selection assistance information (S-NSSAI) information of the target service stream, and the like, which may reduce the quantity of times of interaction between the AO and the NEO.

In some embodiments, the first request message sent by the AO to the NEO may not include target service stream template information, target DNN information and/or target S-NSSAI information of the target service stream, and the like. The AO may send the AO ID, the target service stream template information, the target DNN information of the target service stream, and/or the target S-NSSAI information to the NEO through another message in advance, and the NEO may store the AO ID in association with the target service stream template information, the target DNN information and/or the target S-NSSAI information of the target service stream, and the like. Based on receiving the first request message, the NEO may search according to the AO ID carried in the first request message, to obtain the target DNN information and/or the target S-NSSAI information of the target service stream and the like, thereby reducing the amount of data carried in the first request message.

In some embodiments, the target service stream template information may include one or more of a source IP address (source network address), a source port number, a destination IP address (destination network address), a destination port number, a fully qualified domain name (FQDN), an application identity (APP ID), and the like of the target service stream.

42: Based on receiving the first request message sent by the AO, the NEO performs authentication and certification on the first request message.

43: The NEO returns a first response message to the AO, and the first response message may include indication information for indicating whether to agree on the first request message.

In some embodiments, the AO may send the first request message to the NEO, and the first request message may carry association information of the packet; and based on receiving the first request message sent by the AO, the NEO may perform authentication and certification on the first request message, generate the corresponding first response message, and return the first response message to the AO.

The first response message may include the indication information for indicating whether the first request message is agreed on. If authentication and certification on the first request message succeed, the indication information indicates that the first request message is agree on; or if authentication and certification on the first request message fail, the indication information indicates that the first request message is refused, and in some embodiments, may further include a refusal reason value.

44: The NEO sends the external dependency information to a PCO directly or indirectly.

In some embodiments, based on authentication and certification performed by the NEO on the first request message succeeding, the NEO may then send the association information of the packet, the target service stream template information, the target DNN information and/or the target S-NSSAI information of the target service stream, and the like that are carried in the first request message to the PCO.

45: Based on receiving the external dependency information sent by the NEO, the PCO may determine, according to the external dependency information, dependency information that is of a packet in a core network and that corresponds to the external dependency information, and generate a first policy and charging control (PCC) rule according to the external dependency information and the dependency information that is of the packet in the core network and that corresponds to the external dependency information; and add the external dependency information and the dependency information that is of the packet in the core network and that corresponds to the external dependency information to the first PCC rule, and then send the first PCC rule to an SMO.

In some embodiments, the SMO may generate a target service stream template according to the target service stream template information. The PCO may obtain the target service stream template information from the first request message sent by the AO, or may obtain the target service stream template information in another manner. This is not limited.

In some embodiments, the target service stream template may include one or more of a source IP address, a source port number, a destination IP address, a destination port number, an FQDN, an APP ID, an IP (Internet Protocol) protocol, and the like.

In some embodiments, the first detection rule may indicate whether the first detection rule is valid for an uplink service stream, or valid for a downlink service stream, or valid for both an uplink service stream and a downlink service stream, for example, the first detection rule may further include the uplink/downlink validity indication.

For example, the target service stream template of the first detection rule may include an FQDN, and whether the first detection rule is valid for an uplink service stream, or valid for a downlink service stream, or valid for both an uplink service stream and a downlink service stream may be further indicated through the uplink/downlink validity indication.

In some embodiments, the SMO may define different detection rules, and one detection rule of or a combination of several detection rules may be used as the first detection rule.

In some embodiments, the SMO may reuse a packet detection rule (PDR) as the first detection rule, for example, the dependency information of the packet in the core network is added to a PDR rule. A PDR rule to which the dependency information of the packet in the core network is added and how to add the dependency information of the packet in the core network to a PDR rule may be flexibly set. In some embodiments, the SMO may add a first detection rule and a first processing rule that are new.

In the packet transmission method according to some embodiments, the AO may send the first request message to the NEO, and the first request message carries the external dependency information of the packet of the target service stream and the AO ID, so that the NEO does not need to designate the external dependency information of the packet of the target service stream, and a service server and/or a terminal may designate external dependency information of a packet of a personalized target service stream; and according to some embodiments, the NEO may further send the external dependency information of the packet of the target service stream to the PCO, and the PCO then generates the first PCC rule according to the external dependency information of the packet of the target service stream and sends the first PCC rule to the SMO, so that the SMO may generate the first QoS profile information according to the first PCC rule, and add the first detection rule and the first processing rule to the first QoS profile information, which may optimize network transmission of a to-be-forwarded packet such as a media packet by using the first detection rule and the first processing rule.

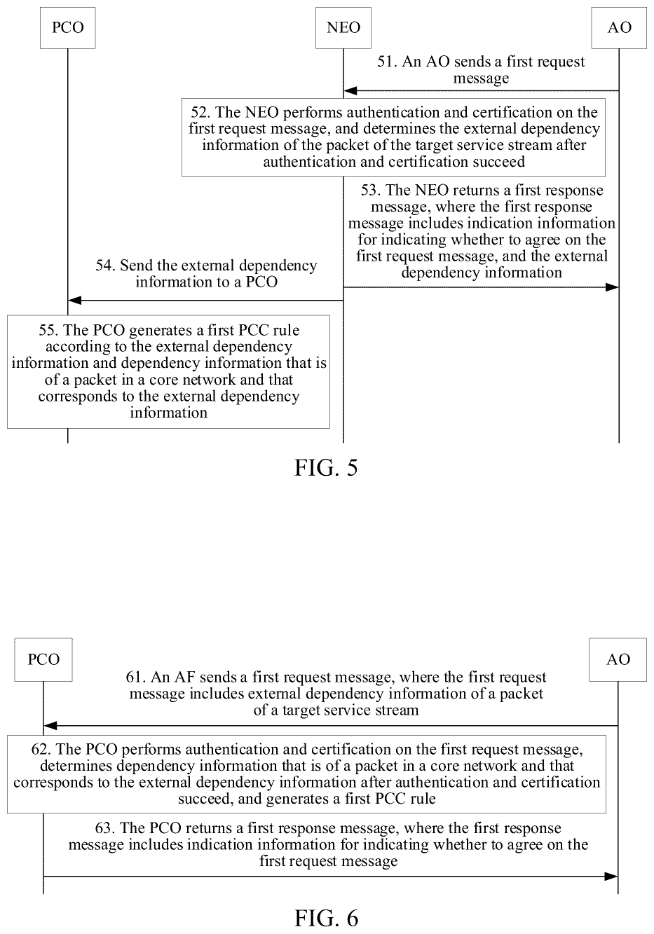

FIG. 5 is a schematic diagram of interaction of a packet transmission method according to some embodiments.

As shown in FIG. 5, the method provided in some embodiments may include:

51: An AO sends a first request message to an NEO, and the first request message does not carry external dependency information of a packet of a target service stream, but the first request message carries an AO ID.

In some embodiments, as illustrated in FIG. 5, for example, the first request message sent by the AO to the NEO may not carry the external dependency information of the packet of the target service stream, for example, the first request message is configured by the AO to instruct the NEO to determine the external dependency information of the packet of the target service stream.

In some embodiments, the first request message may further include at least one of target service stream template information, target DNN information, and/or target S-NSSAI information, which may reduce the quantity of times of interaction between the AO and the NEO.

In some embodiments, the first request message sent by the AO to the NEO may not include target service stream template information, target DNN information and/or target S-NSSAI information of the target service stream, and the like. The AO may send the AO ID, the target service stream template information, the target DNN information of the target service stream, and/or the target S-NSSAI information to the NEO through another message in advance, and the NEO may store the AO ID in association with the target service stream template information, the target DNN information and/or the target S-NSSAI information of the target service stream, and the like. Based on receiving the first request message, the NEO may search according to the AO ID carried in the first request message, to obtain the target DNN information and/or the target S-NSSAI information of the target service stream and the like, thereby reducing the amount of data carried in the first request message.

52: The NEO receives the first request message sent by the AO, and performs authentication and certification on the first request message; and may further determine the external dependency information of the packet of the target service stream based on authentication and certification succeeding.

53: The NEO returns a first response message to the AO, and the first response message may include indication information for indicating whether to agree on the first request message, and the first response message may further include the external dependency information.

54: The NEO sends the external dependency information to a PCO directly or indirectly.

55: Based on receiving the external dependency information sent by the NEO, the PCO may determine, according to the external dependency information, dependency information that is of a packet in a core network and that corresponds to the external dependency information, and generate a first PCC rule according to the external dependency information and the dependency information that is of the packet in the core network and that corresponds to the external dependency information.

In the packet transmission method according to some embodiments, the first request message sent by the AO does not include the external dependency information of the packet of the target service stream, and the NEO designates the external dependency information of the packet of the target service stream, thereby avoiding a problem that a conflict occurs between external dependency information of packets of target service streams configured by different AOs.

Although an example in which the AO exchanges information with the PCO through the NEO is used in the illustrations of FIG. 4 and FIG. 5, the disclosure is not limited thereto. In some embodiments, the AO may directly communicate with the PCO, for example, the PCO obtains association information of a packet directly from the AO; and the NEO may store information requested by the AO in a unified data repository (UDR), and the PCO may receive the information from the UDR.

FIG. 6 is a schematic diagram of interaction of a packet transmission method according to some embodiments.

As shown in FIG. 6, the method provided in some embodiments may include:

61: An AO sends a first request message to a PCO, and the first request message carries an AO ID and external dependency information of a packet of a target service stream.

In some embodiments, the first request message may further include at least one of target service stream template information, target DNN information, and/or target S-NSSAI information, and the like, thereby reducing the quantity of times of interaction between the AO and the PCO.

In some embodiments, the first request message may not include the target service stream template information, the target DNN information, and/or the target S-NSSAI information, and the like, but instead the target service stream template information, the target DNN information, and/or the target S-NSSAI information, and the like are sent to the PCO in advance. The PCO stores the target service stream template information, the target DNN information, and/or the target S-NSSAI information, and the like in association with the AO ID, which are obtained conveniently through search based on the first request message being received, thereby reducing the amount of data carried in the first request message.

62: The PCO receives the first request message sent by the AO, and performs authentication and certification on the first request message; and determines dependency information that is of a packet in a core network and that corresponds to the external dependency information based on authentication and certification succeeding, and generates a first PCC rule.

63: The PCO returns a first response message to the AO, and the first response message may include indication information for indicating whether to agree on the first request message.

In some embodiments, the AO may be an object abstracted from a service server.

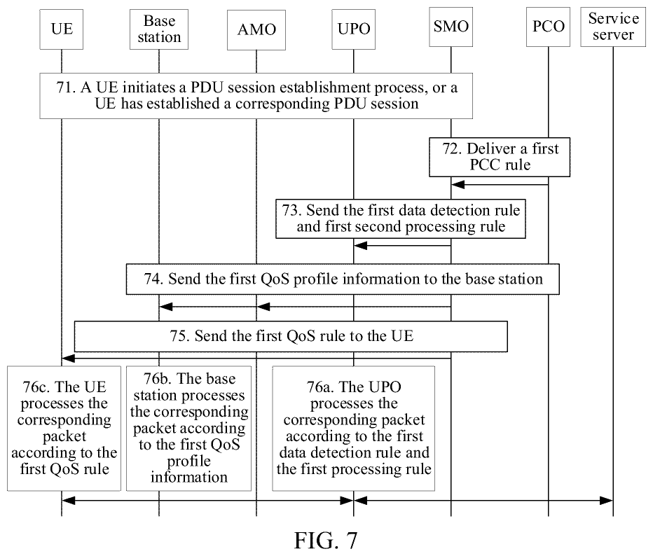

FIG. 7 is a schematic diagram of policy enforcement on a network side. According to some embodiments, FIG. 7 illustrates an example in which a UE is used as a terminal and a base station is used as a network device is taken. As shown in FIG. 7, the method provided in some embodiments may include:

71: A UE initiates a protocol data unit (PDU) session establishment process, or a UE has established a corresponding PDU session.

In some embodiments, the UE has established a PDU session (for example, target DNN or target S-NSSAI) of the target service, or the UE initiates a PDU session establishment process (for example, for target DNN or target S-NSSAI) of the target service.

72: A PCO delivers a first PCC rule to an SMO.

In some embodiments, the first PCC rule may include external dependency information of a packet of a target service stream and dependency information that is of a packet in a core network and that corresponds to the external dependency information.

73: The SMO receives the first PCC rule delivered by the PCO, generates a first detection rule and a first processing rule according to the external dependency information of the packet of the target service stream and the dependency information that is of the packet in the core network and that corresponds to the external dependency information that are carried in the first PCC rule, and generates first QoS profile information according to the first detection rule and the first processing rule, and the first QoS profile information may include the first detection rule and the first processing rule, and the first detection rule may include the dependency information of the packet in the core network; and sends the first detection rule and the first processing rule to a UPO, and the UPO herein may be an anchor UPO or may be an intermediate UPO.

In some embodiments, the SMO may further generate a third detection rule and a third processing rule according to the first PCC rule, and the third detection rule may include the external dependency information of the packet of the target service stream, and the third processing rule may include the dependency information that is of the packet in the core network and that corresponds to the external dependency information; and send the third detection rule and the third processing rule to the anchor UPO, and the third detection rule is configured for instructing the anchor UPO to detect whether external dependency information of a downlink packet received by the anchor UPO from a service server matches the external dependency information of the packet of the target service stream in the third detection rule.

The third processing rule is configured for instructing the anchor UPO to, if the external dependency information of the downlink packet matches the external dependency information of the packet of the target service stream included in the third detection rule, perform marking in a packet header of the downlink packet with the corresponding dependency information of the packet in the core network in the third processing rule during encapsulation of the downlink packet, encapsulate the downlink packet, and send the encapsulated downlink packet marked with the dependency information of the packet in the core network to the network device; or to, if the external dependency information of the downlink packet does not match the external dependency information of the packet of the target service stream included in the third detection rule (the external dependency information does not exist in the downlink packet, or the external dependency information exists, but is different from the external dependency information in the third detection rule), not mark the downlink packet with the corresponding dependency information of the packet in the core network in the third processing rule during encapsulation of the downlink packet, and transmit the encapsulated downlink packet not marked with the dependency information of the packet in the core network to the network device.

74: The SMO may further generate first QoS profile information according to the first PCC rule, and send the first QoS profile information to an AMO, and the first QoS profile information may include the first detection rule and the first processing rule.

In some embodiments, the SMO sends the first QoS profile information or updated first QoS profile information to the AMO, and the first QoS profile information includes the first detection rule and the first processing rule.

The AMO receives the first QoS profile information sent by the SMO, and sends the first QoS profile information to the base station.

The base station receives the first QoS profile information sent by the AMO.

In some embodiments, the base station is a point prone to congestion, and the first QoS profile information may be configured in the base station, to detect and process an uplink packet sent by the UE and a downlink packet sent by the service server separately.

75: The SMO may further generate a first QoS rule according to the first PCC rule, and the first QoS rule may include the external dependency information of the packet of the target service stream and the dependency information that is of the packet in the core network and that corresponds to the external dependency information; and send the first QoS rule to the UE.

76a: The UPO processes the corresponding packet according to the first detection rule and the first processing rule.

The intermediate UPO and/or the anchor UPO processes the target service stream according to the first detection rule and the first processing rule. Reference may also be made to the process in which the network device processes the to-be-forwarded packet by using the first QoS profile information according to some embodiments.

In some embodiments, the UPO is a point prone to congestion, and the first detection rule and the first processing rule may be configured in the UPO, to detect and process an uplink packet sent by the UE or a downlink packet sent by the service server.

The anchor UPO may further receive the third detection rule and the third processing rule, and determine whether external dependency information of a downlink packet received from a service server matches the external dependency information of the packet of the target service stream in the third detection rule.

Based on detecting that the external dependency information of the downlink packet received by the anchor UPO matches the external dependency information of the packet of the target service stream included in the third detection rule, the anchor UPO may perform marking in a packet header of the downlink packet with the corresponding dependency information of the packet in the core network in the third processing rule during encapsulation of the downlink packet, encapsulate the downlink packet, and send the encapsulated downlink packet marked with the dependency information of the packet in the core network to the network device; or based on detecting that the external dependency information of the downlink packet received by the anchor UPO does not match the external dependency information of the packet of the target service stream included in the third detection rule, the anchor UPO may not mark the downlink packet with the corresponding dependency information of the packet in the core network in the third processing rule during encapsulation of the downlink packet, encapsulate the downlink packet, and transmit the encapsulated downlink packet not marked with the dependency information of the packet in the core network to the network device.

For example, the anchor UPO may perform GPRS Tunneling Protocol (GTP) encapsulation on the downlink packet, and perform marking in the packet header of the downlink packet with the dependency information of the packet in the core network, to be configured by the base station to determine a downlink packet which is discarded or transmitted.

76b: The base station processes the corresponding packet according to the first QoS profile information.

76c: The UE processes the corresponding packet according to the first QoS rule.

Based on receiving the first QoS rule, if it is detected that the external dependency information of the uplink packet to be sent by the UE matches the external dependency information of the packet of the target service stream included in the first QoS rule, the UE may mark the uplink packet in a packet header of the uplink packet with the corresponding dependency information of the packet in the core network in the first QoS rule, and send the uplink packet marked with the dependency information of the packet in the core network to the network device; or based on detecting that the external dependency information of the uplink packet does not match the external dependency information of the packet of the target service stream included in the first QoS rule, the UE may not mark the uplink packet with the corresponding dependency information of the packet in the core network in the first QoS rule, but directly transmit the uplink packet to the network device.

An execution sequence of 73, 74, and 75 according to some embodiments, and as illustrated in FIG. 7, for example, is not limited and may be executed in parallel. An execution sequence of 76a, 76b, and 76c is not limited and may be executed in parallel.

In the packet transmission method according to some embodiments, network transmission of a packet such as a media packet is optimized, and based on different packets having a close dependence relationship, if a packet that is depended on is lost for a reason such as congestion, decoding of an image or a video corresponding to another packet in dependence on the packet cannot be completed on the client side or service server side. The network may perform corresponding transmission optimization, to ensure service experience of a target service such as a multimedia service as much as possible and additionally lessening data transmission load on the network.

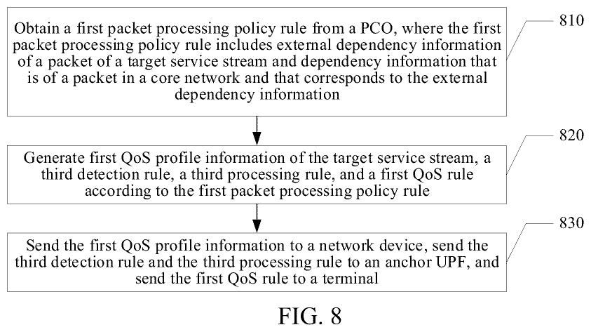

FIG. 8 is a flowchart of a packet transmission method according to some embodiments. The method illustrated in FIG. 8 may be performed by an SMO.

As shown in FIG. 8, the method provided in some embodiments may include:

810: Obtain a first packet processing policy rule from a PCO, and the first packet processing policy rule may include external dependency information of a packet of a target service stream and dependency information that is of a packet in a core network and that corresponds to the external dependency information.

820: Generate first QoS profile information of the target service stream, a third detection rule, a third processing rule, and a first QoS rule according to the first packet processing policy rule, and the first QoS profile information may include a first detection rule and a first processing rule, the first detection rule may include the dependency information, the first QoS rule may include the external dependency information and the dependency information that is of the packet in the core network and that corresponds to the external dependency information, and the third detection rule and the third processing rule may include the external dependency information and the dependency information that is of the packet in the core network and that corresponds to the external dependency information respectively.

830: Send the first QoS profile information to a network device, send the third detection rule and the third processing rule to an anchor UPO, and send the first QoS rule to a terminal.

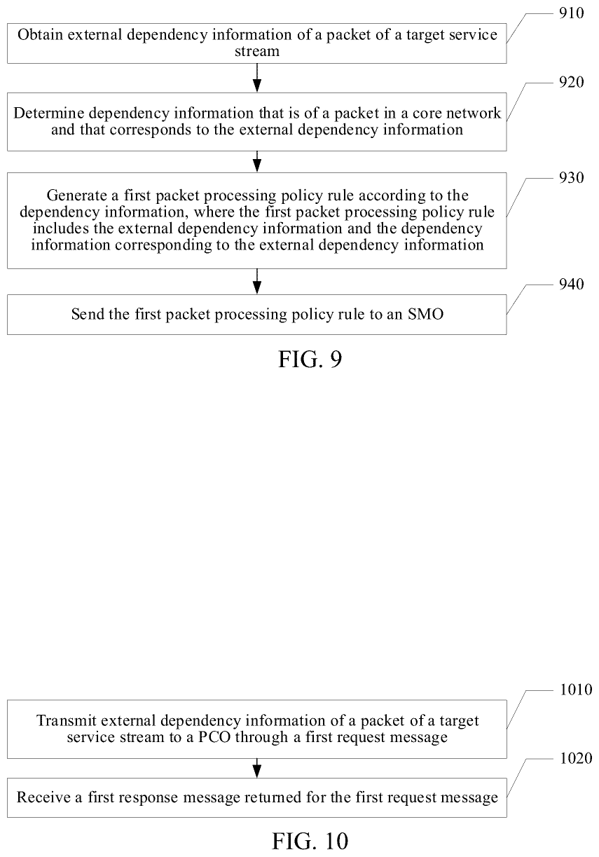

FIG. 9 is a flowchart of a packet transmission method according to some embodiments. The method, as illustrated in FIG. 9, for example, may be performed by a PCO.

As shown in FIG. 9, the method provided in some embodiments may include:

910: Obtain external dependency information of a packet of a target service stream.

920: Determine dependency information that is of a packet in a core network and that corresponds to the external dependency information.

930: Generate a first packet processing policy rule according to the dependency information, and the first packet processing policy rule may include the external dependency information and the dependency information corresponding to the external dependency information.

940: Send the first packet processing policy rule to an SMO.

FIG. 10 is a flowchart of a packet transmission method according to some embodiments. The method, as illustrated in FIG. 10, for example, may be performed by an AO.

As shown in FIG. 10, the method provided in some embodiments may include:

1010: Transmit external dependency information of a packet of a target service stream to a PCO through a first request message.

1020: Receive a first response message returned for the first request message.

The first request message may be configured for instructing the PCO to determine dependency information of a packet in a core network corresponding to the external dependency information according to the external dependency information, and generate a first packet processing policy rule, and the first packet processing policy rule may include the external dependency information and the dependency information.

Further, some embodiments further provide a packet transmission method. The method may be performed by a UPO (which may be an anchor UPO or an intermediate UPO), and the method may include: obtaining a first detection rule and a first processing rule of a target service stream from an SMO, and the first detection rule may include dependency information of a packet in a core network; receiving a to-be-forwarded packet; and processing the to-be-forwarded packet according to the first detection rule and the first processing rule.

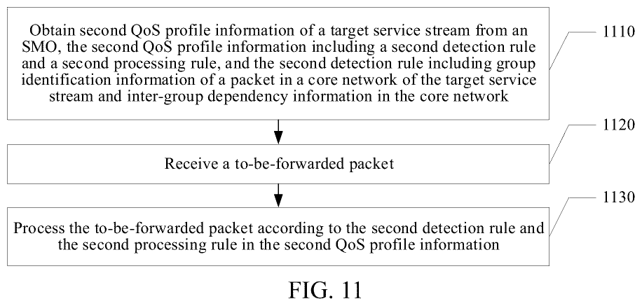

FIG. 11 is a flowchart of a packet transmission method according to some embodiments. The method, as illustrated in FIG. 11, for example, may be performed by a network device (for example, base station), and a network device in some embodiments may be, for example, the network device 110 in FIG. 1, but the disclosure is not limited thereto. Any communication device that is to detect and process a packet may use the method provided in some embodiments.

As shown in FIG. 11, the method provided in some embodiments may include:

1110: Obtain second QoS profile information of a target service stream from an SMO, and the second QoS profile information may include a second detection rule and a second processing rule, and the second detection rule may include group identification information of a packet in a core network of the target service stream and inter-group dependency information in the core network.

In some embodiments, the base station may receive the second QoS profile information of the target service stream from the SMO, and the second QoS profile information may include the second detection rule and the second processing rule.

In some embodiments, the second detection rule may include group identification information of a packet in a core network of the target service stream and inter-group dependency information in the core network.

The group identification information of the packet in the core network refers to identification information that is determined by a network, for example, a PCO in the core network and that is configured for indicating groups to which different packets belong.

In some embodiments, packets may be grouped in various proper manners. For example, grouping may be performed according to dependency between packets, packets having a dependence relationship may be placed into the same group, and packets having no dependence relationship may be placed into different groups. For another example, grouping may be performed according to different characteristics of packets, packets having the same characteristic or similar characteristics are placed into the same group, and packets having different characteristics are placed into different groups. For example, audio packets are placed into the same group, and video packets are placed into the same group; or in video packets, I frames are placed into the same group, P frames are placed into another group, and B frames are placed into another group. For another example, grouping may be performed according to importance degrees of packets, key information in a target service stream is placed into the same group, and non-key information is placed into another group. Alternatively, packets with key information and non-key information having a dependence relationship in a target service stream may be placed into a group, packets with other key information and non-key information having a dependence relationship may be placed into another group, the quantity of groups is not limited, and the several groups may have a dependency or may not have a dependency between each other. The grouping manner is not limited.

The inter-group dependency information of the packet in the core network refers to identification information that is determined by a network, for example, a PCO in the core network and that is configured for indicating, based on different packets belonging to different groups respectively, whether the packets in the different groups have interdependency between each other. This interdependency may be set according to an actual scenario, for example, whether a packet in another group may be correctly decoded and/or correctly received in dependence on a to-be-forwarded packet in the another group.

For example, assuming that a packet 1 belongs to a group 1 and a packet 2 belongs to a group 2, if the packet 2 is decoded in dependence on the packet 1, it is considered that packets in the group 1 and the group 2 have dependency between each other. Group identification information of the group 1 and the inter-group dependency information of the packet in the core network may be included in a packet header of the packet 1, to indicate that the packet 1 belongs to the group 1, and the packet 1 is depended on by a packet in another group. In some embodiments, the packet header of the packet 1 may further indicate a group by which the packet is depended on. Further, the packet header of the packet 1 may further indicate one or more packets in a group by which the packet is depended on. For example, the packet header of the packet 1 may further include group identification information of the group 2 and identification information of the packet 2 (for example, a frame number, but the disclosure is not limited thereto).

In some embodiments, inter-group dependency information of a packet in the core network may be configured for indicating whether the to-be-forwarded packet is depended on by a packet in another group and/or whether the to-be-forwarded packet depends on a packet in another group. In each of the following exemplary descriptions, that inter-group dependency information of a packet in the core network is configured for indicating whether the to-be-forwarded packet is depended on by a packet in another group is used as an example, but the disclosure is not limited thereto.

In some embodiments, the second detection rule may further include data group dependency information. The data group dependency information refers to identification information that is determined by a network, for example, a PCO in the core network and that may be configured for distinguishing whether the received to-be-forwarded packet belongs to the dependency data group.

In some embodiments, how to perform grouping may be determined according to whether there is a close dependence relationship between different packets. For example, a plurality of packets having a close dependence relationship are placed into the same group, and corresponding group identification information is allocated to the packets in the group; and data group dependency information may be further added to the packets in the group, to indicate that the packets in the group are grouped according to the dependence relationship between the packets.

1120: Receive a to-be-forwarded packet.

1130: Process the to-be-forwarded packet according to the second detection rule and the second processing rule in the second QoS profile information.

In some embodiments, the processing the to-be-forwarded packet according to the second detection rule and the second processing rule in the second QoS profile information may include: based on congestion occurring in a network, transmitting the to-be-forwarded packet according to the second processing rule if it is determined that group identification information and inter-group dependency information of the to-be-forwarded packet satisfy the second detection rule; or discarding the to-be-forwarded packet according to the second processing rule if it is determined that group identification information of the to-be-forwarded packet satisfies the second detection rule and inter-group dependency information of the to-be-forwarded packet does not satisfy the second detection rule.

In some embodiments, the base station may detect the received to-be-forwarded packet, to determine whether the received to-be-forwarded packet belongs to packets of the target service stream (including an uplink packet and a downlink packet), and based on determining that the received to-be-forwarded packet belongs to the packets of the target service stream, detect, by using the second detection rule, whether the packet group identification information and the inter-group dependency information of the to-be-forwarded packet match group identification information and inter-group dependency information of a packet in the core network in the second detection rule.

The determining that the packet group identification information and the inter-group dependency information of the to-be-forwarded packet match packet group identification information and inter-group dependency information of a packet in the core network in the second detection rule indicates that the to-be-forwarded packet includes the packet group identification information and the inter-group dependency information of the packet in the core network and the packet group identification information and the inter-group dependency information of the packet in the core network included in the to-be-forwarded packet are the same as the packet group identification information and the inter-group dependency information of the packet in the core network in the first detection rule.

The determining that the dependency information of the to-be-forwarded packet does not match packet group identification information and inter-group dependency information of a packet in the core network in the second detection rule indicates that the to-be-forwarded packet does not include the packet group identification information and the inter-group dependency information of the packet in the core network; or that although the to-be-forwarded packet includes the packet group identification information and the inter-group dependency information of the packet in the core network, the packet group identification information and the inter-group dependency information of the packet in the core network included in the to-be-forwarded packet are different from the packet group identification information and the inter-group dependency information of the packet in the core network in the first detection rule.

In some embodiments, the second processing rule may be configured for instructing the network device, based on congestion occurring in a network, to transmit the to-be-forwarded packet if it is detected that the packet group identification information and the inter-group dependency information of the to-be-forwarded packet satisfy the second detection rule, and discard another packet that does not satisfy the second detection rule; or discard the to-be-forwarded packet compared with another packet satisfying the second packet detection rule if it is detected that the dependency information of the to-be-forwarded packet does not satisfy the second detection rule.

In some embodiments, the second detection rule may further include intra-group dependency information in the core network.

The intra-group dependency information of the packet in the core network refers to identification information that is determined by a network, for example, a PCO in the core network and that is configured for indicating, based on different packets belonging to the same group, whether the different packets have interdependency between each other.

For example, assuming that both a packet 1 and a packet 3 belong to a group 1, if the packet 3 is decoded in dependence on the packet 1, it is considered that the packet 1 and the packet 3 have dependency between each other. Group identification information of the group 1 and the intra-group dependency information of the packet in the core network may be included in a packet header of the packet 1, to indicate that the packet 1 belongs to the group 1, and the packet 1 is depended on by another packet in the group 1. In some embodiments, the packet header of the packet 1 may further indicate one or more packets in the group 1 by which the packet is depended on. For example, the packet header of the packet 1 may further include identification information of the packet 3.

The transmitting the to-be-forwarded packet according to the second processing rule if it is determined that group identification information and inter-group dependency information of the to-be-forwarded packet satisfy the second detection rule may include: transmitting the to-be-forwarded packet according to the second processing rule if it is determined that the group identification information, the inter-group dependency information, and intra-group dependency information of the to-be-forwarded packet satisfy the second detection rule.

In some embodiments, the base station may detect the received to-be-forwarded packet, to determine whether the received to-be-forwarded packet belongs to packets of the target service stream (including an uplink packet and a downlink packet), and based on determining that the received to-be-forwarded packet belongs to the packets of the target service stream, detect, by using the second detection rule, whether the packet group identification information, the inter-group dependency information, and the intra-group dependency information of the to-be-forwarded packet match group identification information, inter-group dependency information, and intra-group dependency information of a packet in the core network in the second detection rule.

In some embodiments, the second processing rule may be configured for instructing the network device, based on congestion occurring in a network, to transmit the to-be-forwarded packet in which both inter-group dependence and intra-group dependence exist if it is detected that each of the group identification information, the inter-group dependency information, and the intra-group dependency information of the to-be-forwarded packet satisfies the second detection rule; or discard, based on congestion occurring in a network, the to-be-forwarded packet in which neither inter-group dependence nor intra-group dependence exists if it is detected that none of the group identification information, the inter-group dependency information, and the intra-group dependency information of the to-be-forwarded packet satisfies the second detection rule.

In some embodiments, the second processing rule may be configured for instructing the network device, based on congestion occurring in a network, to not continue to discard the to-be-forwarded packet in which inter-group dependence exists but intra-group dependence does not exist if the network congestion status may be alleviated based on discarding the packet in which neither inter-group dependence nor intra-group dependence exists, and to not continue to discard the to-be-forwarded packet in which inter-group dependence does not exist but intra-group dependence exists.

If the network congestion status cannot be relieved based on the packet in which neither inter-group dependence nor intra-group dependence exists being discarded, the second processing rule may further instruct the network device to discard, based on detecting that both the group identification information and the inter-group dependency information of the to-be-forwarded packet satisfy the second detection rule but the intra-group dependency information of the to-be-forwarded packet does not satisfy the second packet detection rule (for example, in the to-be-forwarded packet, inter-group dependence exists, but intra-group dependence does not exist), another packet in which intra-group dependence exists but inter-group dependence does not exist compared with another packet whose group identification information and intra-group dependency information satisfy the second packet detection rule but whose inter-group dependency information does not satisfy the second packet detection rule.

If the network congestion status cannot be relieved based on the another packet in which intra-group dependence exists but inter-group dependence does not exist being discarded, the second processing rule may further instruct the network device to continue to discard the to-be-forwarded packet in which inter-group dependence exists but intra-group dependence does not exist.

In some embodiments, If the network congestion status cannot be relieved based on the packet in which neither inter-group dependence nor intra-group dependence exists being discarded, the second processing rule may further instruct the network device to discard, based on detecting that both the group identification information and the inter-group dependency information of the to-be-forwarded packet satisfy the second detection rule but the intra-group dependency information of the to-be-forwarded packet does not satisfy the second packet detection rule (for example, in the to-be-forwarded packet, inter-group dependence exists, but intra-group dependence does not exist), the to-be-forwarded packet in which inter-group dependence exists but intra-group dependence does not exist compared with another packet whose group identification information and intra-group dependency information satisfy the second packet detection rule but whose inter-group dependency information does not satisfy the second packet detection rule.

If the network congestion status cannot be relieved based on the to-be-forwarded packet in which inter-group dependence exists but intra-group dependence does not exist being discarded, the second processing rule may further instruct the network device to continue to discard the another packet in which intra-group dependence exists but inter-group dependence does not exist.

For different packets with a close dependence relationship, if the to-be-forwarded packet depended on by another packet is lost for a reason such as congestion, it is possible that decoding of an image or a video corresponding to the another packet in dependence on the to-be-forwarded packet cannot be completed on the client side or server side. In some embodiments, the group identification information and the inter-group dependency information of the packet in the core network are set in the second detection rule; and are configured for detecting a group to which the received to-be-forwarded packet belongs, and may further detect whether the to-be-forwarded packet is depended on by a packet in another group, and in some embodiments, may further detect whether the to-be-forwarded packet is depended on by another packet in the same group as that of the to-be-forwarded packet. If the to-be-forwarded packet is depended on by a packet in another group and/or another packet in the same group as that of the to-be-forwarded packet, whether to transmit the to-be-forwarded packet is determined according to the second data processing rule, thereby ensuring that the packet in the another group and/or the another packet in the same group in dependence on the to-be-forwarded packet may be correctly received and/or decoded, reducing impact on decoding on the client or server side, and ensuring service experience of a target service such as a multimedia service as much as possible. In some embodiments, the to-be-forwarded packet that is not depended on by the packet in the another group and/or not depended on by the another packet in the same group may be further discarded through the second detection rule and the second processing rule based on congestion occurring in a network, thereby alleviating a network congestion status, reducing occupied transmission resources, and optimizing packet network transmission.

The second detection rule and the second processing rule may be merged into the same rule, or may be divided into different rules, or may be used as a part of another rule, or may be used as a part of a QoS profile. According to different execution entities, the rule may have different names. This is not limited.

In some embodiments, the second detection rule may further include an uplink/downlink validity indication, and the uplink/downlink validity indication may be configured for indicating whether the second detection rule is valid for an uplink packet, or valid for a downlink packet, or valid for both an uplink packet and a downlink packet.

In some embodiments, the network device may determine whether the second detection rule is valid for an uplink service stream, a downlink service stream, or an uplink service stream and a downlink service stream of the target service stream according to the uplink/downlink validity indication; and process, if it is determined that the second detection rule is valid for a downlink service stream, the to-be-forwarded packet according to the second detection rule and the second processing rule in the second QoS profile information based on determining that the to-be-forwarded packet belongs to the downlink service stream of the target service stream; process, if it is determined that the second detection rule is valid for an uplink service stream, the to-be-forwarded packet according to the second detection rule and the second processing rule in the second QoS profile information based on determining that the to-be-forwarded packet belongs to the uplink service stream of the target service stream; or separately detect, if it is determined that the second detection rule is valid for an uplink service stream and a downlink service stream, the uplink service stream and the downlink service stream of the target service stream, and process the to-be-forwarded packet according to the second detection rule and the second processing rule in the second QoS profile information.

Through the uplink/downlink validity indication, network transmission of the packet of the target service stream may be detected and processed more accurately.

In the packet transmission method according to some embodiments, a network device obtains second QoS profile information of a target service stream from an SMO, the second QoS profile information including a second detection rule and a second processing rule, and the second detection rule carrying group identification information and inter-group dependency information of a packet in a core network, so that based on receiving a to-be-forwarded packet, the network device may determine, according to the second detection rule and the second processing rule in the second QoS profile information, how to process the to-be-forwarded packet, to optimize a network transmission process of the to-be-forwarded packet.

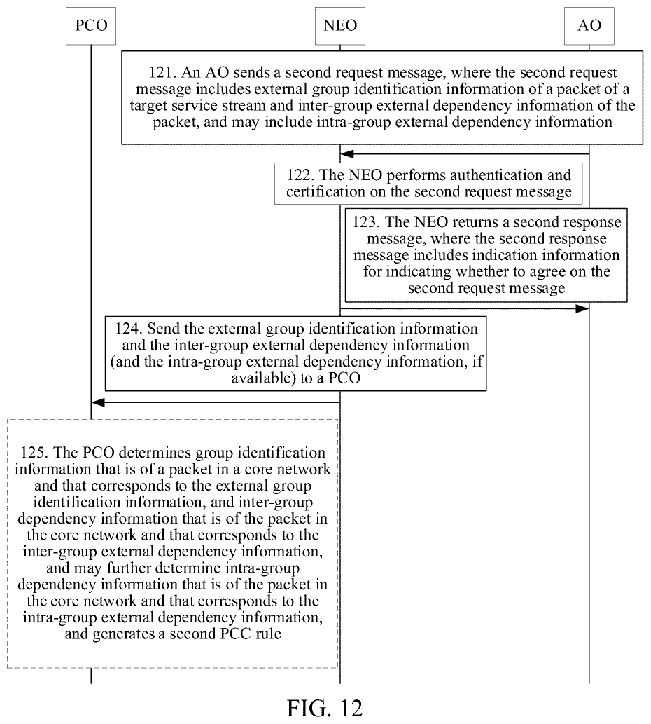

FIG. 12 illustrates a schematic diagram of an AO interaction service requirement based on packets being grouped according to some embodiments. As shown in FIG. 12, the method provided in some embodiments may include:

121: An AO sends a second request message to an NEO, and the second request message may include external group identification information of a packet of a target service stream and inter-group external dependency information of the packet, and in some embodiments, may further include intra-group external dependency information.

In some embodiments, the second request message may include association information of the packet, which is information configured for determining whether the packet may be discarded or continue to be transmitted in network transmission.

For example, the association information of the packet may include the external group identification information and the inter-group external dependency information of the packet of the target service stream. The AO may determine the external group identification information and the inter-group external dependency information of the packet of the target service stream.

In some embodiments, the external group identification information of the packet of the target service stream refers to identification information that is determined by the AO or the NEO and that is configured for indicating a group to which the packet belongs.

In some embodiments, the inter-group external dependency information of the packet of the target service stream refers to identification information that is determined by the AO or the NEO and that is configured for indicating whether interdependency exists between different packets belonging to different groups. This interdependency may be set according to an actual scenario, for example, whether another packet may be correctly decoded and/or correctly received in dependence on the to-be-forwarded packet.

In some embodiments, the second request message sent by the AO to the NEO may further include at least one of AO identification information (represented with AO ID), target service stream template information, target DNN information and/or target S-NSSAI information of the target service stream, and the like, which may reduce the quantity of times of interaction between the AO and the NEO.

In some embodiments, the second request message sent by the AO to the NEO may not include target service stream template information, target DNN information and/or target S-NSSAI information of the target service stream, and the like. The AO may send the AO ID, the target service stream template information, the target DNN information of the target service stream, and/or the target S-NSSAI information to the NEO through another message in advance, and the NEO may store the AO ID in association with the target service stream template information, the target DNN information and/or the target S-NSSAI information of the target service stream, and the like. Based on receiving the second request message, the NEO may search according to the AO ID carried in the second request message, to obtain the target DNN information and/or the target S-NSSAI information of the target service stream and the like, thereby reducing the amount of data carried in the second request message.

122: Based on receiving the second request message sent by the AO, the NEO performs authentication and certification on the second request message.

123: The NEO returns a second response message to the AO, and the second response message may include indication information for indicating whether to agree on the second request message.

In some embodiments, the AO may send the second request message to the NEO, and the second request message may carry association information of the packet; and based on receiving the second request message sent by the AO, the NEO may perform authentication and certification on the second request message, generate the corresponding second response message, and return the second response message to the AO.

The second response message may include the indication information for indicating whether the second request message is agreed on. If authentication and certification on the second request message succeed, the indication information indicates that the second request message is agree on; or if authentication and certification on the second request message fail, the indication information indicates that the second request message is refused, and in some embodiments, may further include a refusal reason value.

124: The NEO sends the external group identification information and the inter-group external dependency information, and in some embodiments, the intra-group external dependency information to a PCO directly or indirectly.

In some embodiments, based on authentication and certification performed by the NEO on the second request message succeeding, the NEO may then send the association information of the packet, the target service stream template information, the target DNN information and/or the target S-NSSAI information of the target service stream, and the like that are carried in the second request message to the PCO.

In some embodiments, in 125, based on receiving the external group identification information and the inter-group external dependency information, and in some embodiments, the intra-group external dependency information that are sent by the NEO, the PCO may determine, according to the external group identification information, group identification information that is of a packet in a core network and that corresponds to the external group identification information, and inter-group dependency information that is of the packet in the core network and that corresponds to the inter-group external dependency information, and in some embodiments, may further determine intra-group dependency information that is of the packet in the core network and that corresponds to the intra-group external dependency information; and may further generate the second PCC rule according to the external group identification information, group identification information that is of a packet in a core network and that corresponds to the external group identification information, the inter-group external dependency information, and inter-group dependency information that is of the packet in the core network and that corresponds to the inter-group external dependency information, and in some embodiments, according to the intra-group external dependency information and intra-group dependency information that is of the packet in the core network and that corresponds to the intra-group external dependency information, and the second PCC rule may carry the external group identification information, the group identification information that is of the packet in the core network and that corresponds to the external group identification information, the inter-group external dependency information, and the inter-group dependency information that is of the packet in the core network and that corresponds to the inter-group external dependency information, and in some embodiments, may further carry the intra-group external dependency information and the intra-group dependency information that is of the packet in the core network and that corresponds to the intra-group external dependency information, and then send the second PCC rule to the SMO.

In some embodiments, the SMO may generate a target service stream template according to the target service stream template information. The PCO may obtain the target service stream template information from the second request message sent by the AO, or may obtain the target service stream template information in another manner. This is not limited.

In some embodiments, the second detection rule may indicate whether the second detection rule is valid for an uplink service stream, or valid for a downlink service stream, or valid for both an uplink service stream and a downlink service stream, for example, the second detection rule may further include the uplink/downlink validity indication.

In some embodiments, the SMO may define different detection rules, and one detection rule of or a combination of several detection rules may be used as the second detection rule.

In some embodiments, the SMO may reuse a PDR as the second detection rule, for example, the group identification information of the packet in the core network and the inter-group dependency information of the packet in the core network and in some embodiments, the intra-group dependency information of the packet in the core network are added to a PDR rule. A PDR rule to which the group identification information of the packet in the core network and the inter-group dependency information of the packet in the core network and in some embodiments, the intra-group dependency information of the packet in the core network are added and how to add the group identification information of the packet in the core network and the inter-group dependency information of the packet in the core network and in some embodiments, the intra-group dependency information of the packet in the core network to a PDR rule may be flexibly set. In some embodiments, the SMO may add a second detection rule and a second processing rule that are new.

In the packet transmission method according to some embodiments, the AO may send the second request message to the NEO, and the second request message carries the external group identification information and the inter-group external dependency information of the packet of the target service stream and the AO ID, and in some embodiments, may further carry the intra-group external dependency information of the target service stream, so that the NEO does not need to designate the external group identification information and the inter-group external dependency information, and in some embodiments, the NEO does not need to designate the intra-group external dependency information, and the service server and/or the terminal may designate external group identification information and inter-group external dependency information of a packet of a personalized target service stream, and in some embodiments, may further designate intra-group external dependency information of a personalized target service stream; and according to some embodiments, the NEO may further send the external group identification information and the inter-group external dependency information of the packet of the target service stream, and in some embodiments, the intra-group external dependency information of the target service stream to the PCO, and the PCO then generates the second PCC rule according to the external group identification information and the inter-group external dependency information of the packet of the target service stream, and in some embodiments, the intra-group external dependency information of the target service stream, and sends the second PCC rule to the SMO, so that the SMO may generate the second QoS profile information according to the second PCC rule, and add the second detection rule and the second processing rule to the second QoS profile information, which may optimize network transmission of a to-be-forwarded packet such as a media packet by using the second detection rule and the second processing rule.

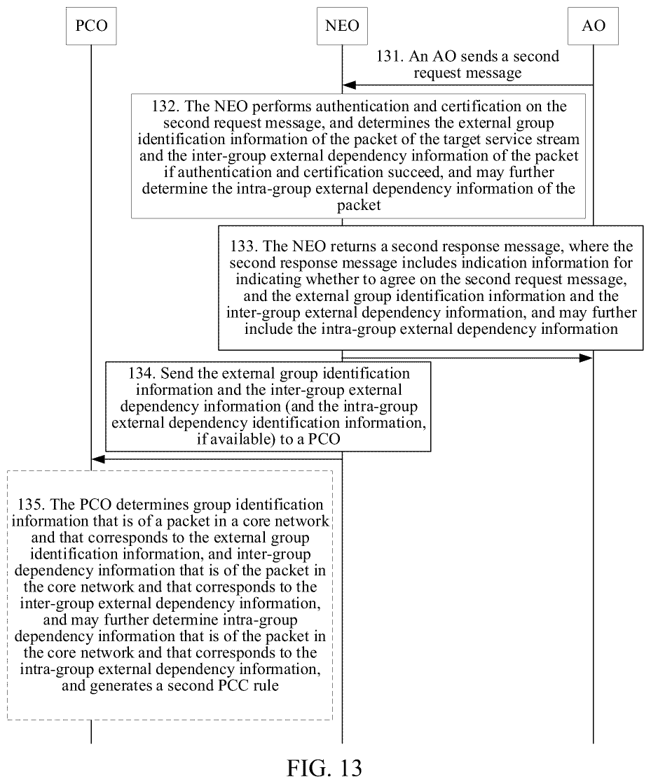

FIG. 13 is a schematic diagram of interaction of a packet transmission method according to some embodiments.

As shown in FIG. 13, the method provided in some embodiments may include:

131: An AO sends a second request message to an NEO, and the second request message does not carry external group identification information and inter-group external dependency information of a packet of a target service stream, and in some embodiments, does not carry intra-group external dependency information of the packet of the target service stream, and the second request message carries an AO ID.

As illustrated in FIG. 13, according to some embodiments, the second request message sent by the AO to the NEO may not carry the external group identification information and the inter-group external dependency information of the packet of the target service stream, and in some embodiments, does not carry the intra-group external dependency information of the packet of the target service stream. The second request message may be configured by the AO to instruct the NEO to determine the external group identification information and the inter-group external dependency information of the packet of the target service stream, and in some embodiments, instruct the NEO to determine the intra-group external dependency information of the packet of the target service stream.

In some embodiments, the second request message may further include at least one of target service stream template information, target DNN information, and/or target S-NSSAI information, which may reduce the quantity of times of interaction between the AO and the NEO.

In some embodiments, the second request message sent by the AO to the NEO may not include target service stream template information, target DNN information and/or target S-NSSAI information of the target service stream, and the like. The AO may send the AO ID, the target service stream template information, the target DNN information of the target service stream, and/or the target S-NSSAI information to the NEO through another message in advance, and the NEO may store the AO ID in association with the target service stream template information, the target DNN information and/or the target S-NSSAI information of the target service stream, and the like. Based on receiving the second request message, the NEO may search according to the AO ID carried in the second request message, to obtain the target DNN information and/or the target S-NSSAI information of the target service stream and the like, thereby reducing the amount of data carried in the second request message.

132: The NEO receives the second request message sent by the AO, and performs authentication and certification on the second request message; and may further determine the external group identification information and the inter-group external dependency information of the packet of the target service stream based on authentication and certification succeeding, and in some embodiments, may determine the intra-group external dependency information of the packet of the target service stream.

133: The NEO returns a second response message to the AO, and the second response message may include indication information for indicating whether to agree on the second request message, and the second response message may further include the external group identification information and the inter-group external dependency information of the packet of the target service stream, and in some embodiments, may include the intra-group external dependency information of the packet of the target service stream.

134: The NEO sends the external group identification information and the inter-group external dependency information of the packet of the target service stream, and in some embodiments, the intra-group external dependency information of the packet of the target service stream to a PCO directly or indirectly.

135: The PCO may generate a second PCC rule based on receiving the external group identification information and the inter-group external dependency information of the packet of the target service stream sent by the NEO, and in some embodiments, receiving the intra-group external dependency information of the packet of the target service stream.

In the packet transmission method according to some embodiments, the second request message sent by the AO does not include the external group identification information and the inter-group external dependency information of the packet of the target service stream, and in some embodiments, may not include the intra-group external dependency information, and the NEO designates the external group identification information and the inter-group external dependency information of the packet of the target service stream, and in some embodiments, the NEO may designate the intra-group external dependency information, thereby avoiding a problem that a conflict occurs between external group identification information and inter-group external dependency information (in some embodiments, intra-group external dependency information) of packets of target service streams configured by different AOs.

Although an example in which the AO exchanges information with the PCO through the NEO is used in some embodiments as illustrated in FIG. 12 and FIG. 13, for example, the disclosure is not limited thereto. In some embodiments, the AO may directly communicate with the PCO, for example, the PCO obtains association information of a packet directly from the AO; and the NEO may store information requested by the AO in a UDR, and the PCO may receive the information from the UDR.

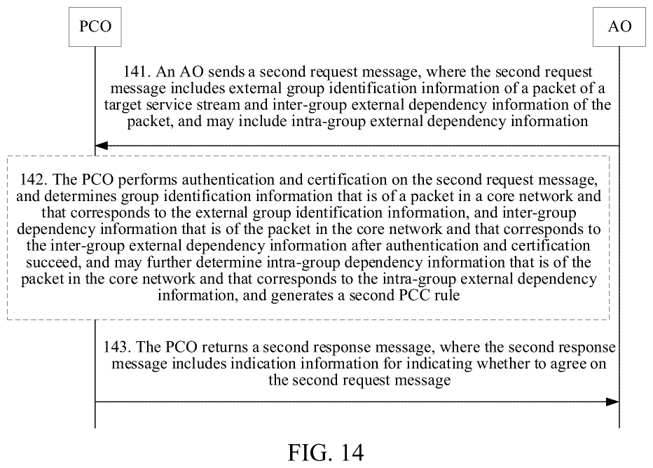

FIG. 14 is a schematic diagram of interaction of a packet transmission method according to some embodiments.

As shown in FIG. 14, the method provided in some embodiments may include:

141: An AO sends a second request message to a PCO, and the second request message carries an AO ID and external group identification information and inter-group external dependency information of a packet of a target service stream, and in some embodiments, may further include intra-group external dependency information.

In some embodiments, the second request message may further include at least one of target service stream template information, target DNN information, and/or target S-NSSAI information, and the like, thereby reducing the quantity of times of interaction between the AO and the PCO.

In some embodiments, the second request message may not include the target service stream template information, the target DNN information, and/or the target S-NSSAI information, and the like, but instead the target service stream template information, the target DNN information, and/or the target S-NSSAI information, and the like are sent to the PCO in advance. The PCO stores the target service stream template information, the target DNN information, and/or the target S-NSSAI information, and the like in association with the AO ID, which are obtained conveniently through search based on the second request message being received, thereby reducing the amount of data carried in the second request message.

142: The PCO receives the second request message sent by the AO, and performs authentication and certification on the second request message; and determines group identification information that is of a packet in a core network and that corresponds to the external group identification information, and inter-group dependency information that is of the packet in the core network and that corresponds to the inter-group external dependency information based on authentication and certification succeeding, and in some embodiments, may further determine intra-group dependency information that is in the core network and that corresponds to the intra-group external dependency information, and generates a second PCC rule.

143: The PCO returns a second response message to the AO, and the second response message may include indication information for indicating whether to agree on the second request message.

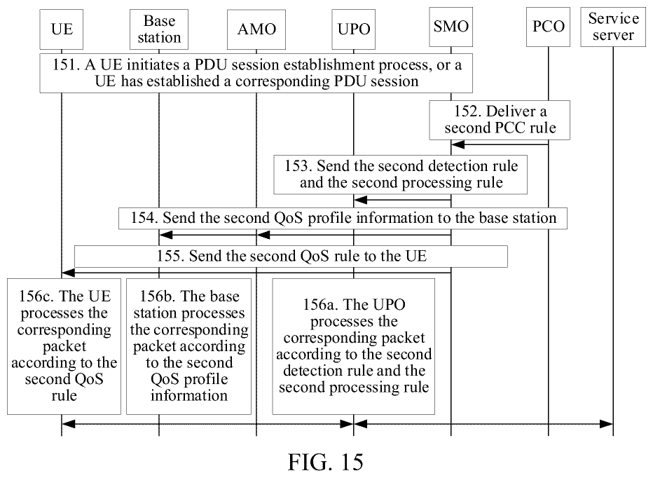

FIG. 15 is a schematic diagram of policy enforcement on a network side. According to some embodiments, FIG. 15, an example in which a UE is used as a terminal and a base station is used as a network device is taken. As shown in FIG. 15, the method provided in some embodiments may include:

151: A UE initiates a PDU session establishment process, or a UE has established a corresponding PDU session.

In some embodiments, the UE has established a PDU session (for example, target DNN or target S-NSSAI) of the target service, or the UE initiates a PDU session establishment process (for example, for target DNN or target S-NSSAI) of the target service.

152: A PCO delivers a second PCC rule to an SMO.

In some embodiments, the second PCC rule may include external group identification information of a packet of a target service stream, group identification information that is of a packet in a core network and that corresponds to the external group identification information, inter-group external dependency information, and inter-group dependency information that is of the packet in the core network and that corresponds to the inter-group external dependency information, and in some embodiments, may further include intra-group external dependency information of the packet of the target service stream and intra-group dependency information that is of the packet in the core network and that corresponds to the intra-group external dependency information.

153: The SMO receives the second PCC rule delivered by the PCO, generates a second detection rule and a second processing rule according to the external group identification information of the packet of the target service stream, the group identification information that is of the packet in the core network and that corresponds to the external group identification information, the inter-group external dependency information, and the inter-group dependency information that is of the packet in the core network and that corresponds to the inter-group external dependency information that are carried in the second PCC rule, and in some embodiments, according to the intra-group external dependency information of the packet of the target service stream and the intra-group dependency information that is of the packet in the core network and that corresponds to the intra-group external dependency information that are carried in the second PCC rule, and generates second QoS profile information according to the second detection rule and the second processing rule, and the second QoS profile information may include the second detection rule and the second processing rule, and the second detection rule may include the group identification information of the packet in the core network and the inter-group dependency information of the packet in the core network, and in some embodiments, the second detection rule may further include the intra-group dependency information of the packet in the core network. The SMO may send the second detection rule and the second processing rule to a UPO. The UPO herein may be an anchor UPO or may be an intermediate UPO.

In some embodiments, the SMO may further generate a fourth detection rule and a fourth processing rule according to the second PCC rule. The fourth detection rule may include the external group identification information and the inter-group external dependency information of the packet of the target service stream. In some embodiments, the fourth detection rule may further include intra-group external dependency information of the packet of the target service stream, and the fourth processing rule may include group identification information that is of a packet in a core network and that corresponds to the external group identification information of the packet of the target service stream, and inter-group dependency information that is of the packet in the core network and that corresponds to the inter-group external dependency information. In some embodiments, the fourth processing rule may further include intra-group dependency information that is of the packet in the core network and that corresponds to the intra-group external dependency information of the packet of the target service stream.

The SMO may send the fourth detection rule and the fourth processing rule to the anchor UPO. The fourth detection rule is configured for instructing the anchor UPO to detect whether external group identification information and inter-group external dependency information of a downlink packet received by the anchor UPO from the service server match the external group identification information and the inter-group external dependency information of the packet of the target service stream in the fourth detection rule, and in some embodiments, may be further configured for instructing the anchor UPO to detect whether intra-group external dependency information of the downlink packet matches the intra-group external dependency information of the packet of the target service stream in the fourth detection rule.

The fourth processing rule is configured for instructing the anchor UPO to, if the external group identification information and the inter-group external dependency information of the downlink packet matches the external group identification information and the inter-group external dependency information of the packet of the target service stream included in the fourth detection rule, mark the downlink packet with the corresponding group identification information in the core network in the fourth processing rule and the inter-group dependency information of the packet in the core network during encapsulation of the downlink packet, and send the encapsulated downlink packet marked with the group identification information of the packet in the core network and the inter-group dependency information of the packet in the core network to the network device;

In some embodiments, if the inter-group external dependency information of the downlink packet matches the inter-group external dependency information of the packet of the target service stream included in the fourth detection rule, mark the downlink packet with the corresponding inter-group dependency information of the packet in the core network in the fourth processing rule during encapsulation of the downlink packet, and send the encapsulated downlink packet marked with the inter-group dependency information of the packet in the core network to the network device;

if the external group identification information of the downlink packet does not match the external group identification information in the fourth detection rule or the inter-group external dependency information of the downlink packet does not match the inter-group external dependency information of the packet of the target service stream included in the fourth detection rule (the inter-group external dependency information does not exist in the downlink packet, or the inter-group external dependency information exists, but is different from the inter-group external dependency information in the fourth detection rule), not mark the downlink packet with the corresponding group identification information and inter-group dependency information of the packet in the core network in the fourth processing rule during encapsulation of the downlink packet, but directly transmit the encapsulated downlink packet not marked with the group identification information and the inter-group dependency information of the packet in the core network to the network device; or

In some embodiments, if the inter-group external dependency information of the downlink packet does not match the inter-group external dependency information of the packet of the target service stream included in the fourth detection rule, not mark the downlink packet with the corresponding inter-group dependency information of the packet in the core network in the fourth processing rule during encapsulation of the downlink packet.

154: The SMO may further generate second QoS profile information according to the second PCC rule, and send the second QoS profile information to an AMO, and the second QoS profile information may include the second detection rule and the second processing rule.

In some embodiments, the SMO sends the second QoS profile information or updated second QoS profile information to the AMO, and the second QoS profile information includes the second detection rule and the second processing rule.

The AMO receives the second QoS profile information sent by the SMO, and sends the second QoS profile information to the base station.

The base station receives the second QoS profile information sent by the AMO.

In some embodiments, the base station is a point prone to congestion, and the second QoS profile information may be configured in the base station, to detect and process an uplink packet sent by the UE and a downlink packet sent by the service server separately.

155: The SMO may further generate a second QoS rule according to the second PCC rule, and the second QoS rule may include external group identification information of a packet of a target service stream, group identification information that is of a packet in a core network and that corresponds to the external group identification information, inter-group external dependency information, and inter-group dependency information that is of the packet in the core network and that corresponds to the inter-group external dependency information, and in some embodiments, may further include intra-group external dependency information and intra-group dependency information that is of the packet in the core network and that corresponds to the intra-group external dependency information; and send the second QoS rule to the UE.

156a: The UPO processes the corresponding packet according to the second detection rule and the second processing rule.

The intermediate UPO and/or the anchor UPO processes the target service stream according to the second detection rule and the second processing rule. Reference may also be made to the process in which the network device processes the to-be-forwarded packet by using the second QoS profile information according to some embodiments.

In some embodiments, the UPO is a point prone to congestion, and the second detection rule and the second processing rule may be configured in the UPO, to detect and process an uplink packet sent by the UE or a downlink packet sent by the service server.

The anchor UPO may further receive the fourth detection rule and the fourth processing rule, and determine whether external group identification information and inter-group external dependency information of a downlink packet received from a service server match the external group identification information and the inter-group external dependency information of the packet of the target service stream in the fourth detection rule.

Based on detecting that the external group identification information and the inter-group external dependency information of the downlink packet received by the anchor UPO matches the external group identification information and the inter-group external dependency information of the packet of the target service stream included in the fourth detection rule, the anchor UPO may mark the downlink packet with the corresponding group identification information of the packet in the core network in the fourth processing rule and the inter-group dependency information of the packet in the core network, and send the encapsulated downlink packet marked with the group identification information of the packet in the core network and the inter-group dependency information of the packet in the core network to the network device; or based on detecting that the external group identification information or the inter-group external dependency information of the downlink packet received by the anchor UPO does not match the external dependency information of the packet of the target service stream included in the fourth detection rule, the anchor UPO may not mark the downlink packet with the corresponding group identification information of the packet in the core network in the fourth processing rule and the inter-group dependency information of the packet in the core network during encapsulation of the downlink packet, but directly transmit the encapsulated downlink packet not marked with the group identification information of the packet in the core network and the inter-group dependency information of the packet in the core network to the network device;

In some embodiments, if it is detected that the inter-group external dependency information of the downlink packet matches the inter-group external dependency information of the packet of the target service stream included in the fourth detection rule, the anchor UPO marks the downlink packet with the corresponding inter-group dependency information of the packet in the core network in the fourth processing rule, and sends the encapsulated downlink packet marked with the inter-group dependency information of the packet in the core network to the network device.

If it is detected that the external group identification information of the downlink packet does not match the external group identification information in the fourth detection rule or the inter-group external dependency information of the downlink packet does not match the inter-group external dependency information of the packet of the target service stream included in the fourth detection rule (the inter-group external dependency information does not exist in the downlink packet, or the inter-group external dependency information exists, but is different from the inter-group external dependency information in the fourth detection rule), the anchor UPO does not mark the downlink packet with the corresponding group identification information and inter-group dependency information of the packet in the core network in the fourth processing rule, but transmit the encapsulated downlink packet not marked with the group identification information and the inter-group dependency information of the packet in the core network to the network device.

In some embodiments, if it is detected that the inter-group external dependency information of the downlink packet does not match the inter-group external dependency information of the packet of the target service stream included in the fourth detection rule, the anchor UPO does not mark the downlink packet with the corresponding inter-group dependency information of the packet in the core network in the fourth processing rule, but transmits the encapsulated downlink packet not marked with the inter-group dependency information of the packet in the core network to the network device.

156b: The base station processes the corresponding packet according to the second QoS profile information.

156c: The UE processes the corresponding packet according to the second QoS rule.

Based on detecting that the external group identification information and the inter-group external dependency information of the uplink packet to be sent by the UE matches the external group identification information and the inter-group external dependency information of the packet of the target service stream included in the second QoS rule, the UE may separately mark the uplink packet with the corresponding group identification information and inter-group dependency information of the packet in the core network in the second QoS rule, and send the uplink packet marked with the group identification information and the inter-group dependency information of the packet in the core network to the network device; or based on detecting that the external group identification information or the inter-group external dependency information of the uplink packet does not match the external dependency information of the packet of the target service stream included in the second QoS rule, the UE does not mark the uplink packet with the corresponding group identification information and inter-group dependency information of the packet in the core network in the second QoS rule, but directly transmits the uplink packet to the network device.

In some embodiments, if it is detected that the inter-group external dependency information of the uplink packet matches the inter-group external dependency information of the packet of the target service stream included in the second QoS rule, the UE marks the uplink packet with the corresponding inter-group dependency information of the packet in the core network in the second QoS rule, and sends the uplink packet marked with the inter-group dependency information of the packet in the core network to the network device.

If it is detected that the external group identification information of the uplink packet does not match the external group identification information in the second QoS rule or the inter-group external dependency information of the uplink packet does not match the inter-group external dependency information of the packet of the target service stream included in the second QoS rule (the inter-group external dependency information does not exist in the uplink packet, or the inter-group external dependency information exists, but is different from the inter-group external dependency information in the second QoS rule), the UE does not mark the inter-group external dependency information in the uplink packet with the corresponding inter-group dependency information of the packet in the core network in the second QoS rule, but directly transmits the uplink packet to the network device.

In some embodiments, if it is detected that the inter-group external dependency information of the uplink packet does not match the inter-group external dependency information of the packet of the target service stream included in the second QoS rule, the UE does not mark the uplink packet with the corresponding inter-group dependency information of the packet in the core network in the second QoS rule.

An execution sequence of 153, 154, and 155 according to some embodiments as illustrated in FIG. 15 is not limited and may be executed in parallel. An execution sequence of 156a, 156b, and 156c is not limited and may be executed in parallel.

In the packet transmission method according to some embodiments, network transmission of a packet such as a media packet is optimized, and based on different packets having a close dependence relationship, if a packet that is depended on is lost for a reason such as congestion, decoding of an image or a video corresponding to another packet in dependence on the packet cannot be completed on the client side or service server side. The network may perform corresponding transmission optimization, to ensure service experience of a target service such as a multimedia service as much as possible and additionally lessening data transmission load on the network.

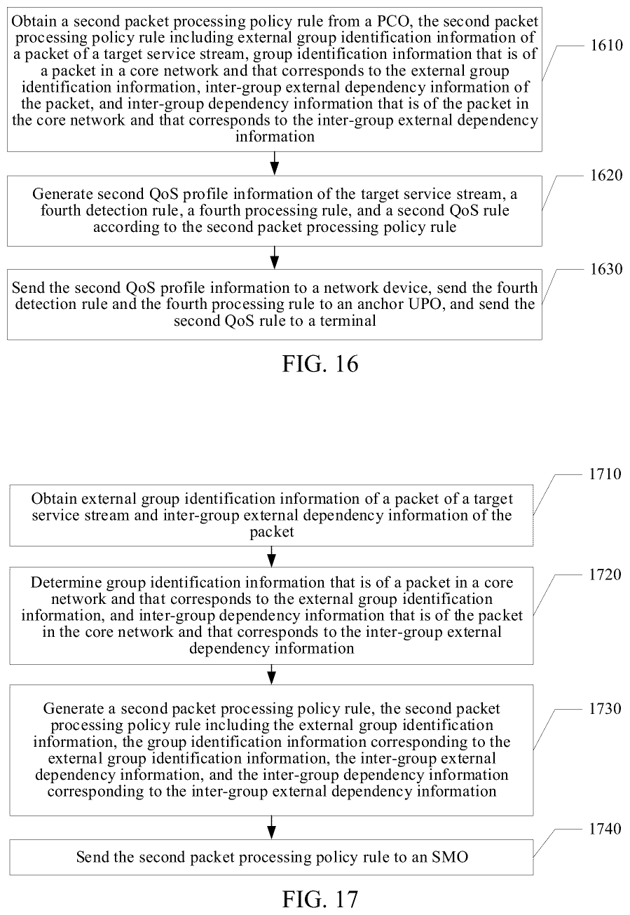

FIG. 16 is a flowchart of a packet transmission method according to some embodiments. The method provided according to some embodiments as illustrated in FIG. 16 may be performed by an SMO.

As shown in FIG. 16, the method provided in some embodiments may include:

1610: Obtain a second packet processing policy rule from a PCO, the second packet processing policy rule including external group identification information of a packet of a target service stream, group identification information that is of a packet in a core network and that corresponds to the external group identification information, inter-group external dependency information of the packet, and inter-group dependency information that is of the packet in the core network and that corresponds to the inter-group external dependency information.

1620: Generate second QoS profile information of the target service stream, a fourth detection rule, a fourth processing rule, and a second QoS rule according to the second packet processing policy rule, and the second QoS profile information may include a second detection rule and a second processing rule, the second detection rule may include the group identification information and the inter-group dependency information, the fourth detection rule may include the external group identification information and the inter-group external dependency information, the fourth processing rule may include the group identification information and the inter-group dependency information, and the second QoS rule may include the external group identification information, the group identification information corresponding to the external group identification information, the inter-group external dependency information, and the inter-group dependency information corresponding to the inter-group external dependency information.

1630: Send the second QoS profile information to a network device, send the fourth detection rule and the fourth processing rule to an anchor UPO, and send the second QoS rule to a terminal.

In some embodiments, the second packet processing policy rule may further include intra-group external dependency information of the packet of the target service stream and intra-group dependency information that is of the packet in the core network and that corresponds to the intra-group external dependency information.

The second detection rule may further include the intra-group dependency information.

The fourth detection rule may further include the intra-group external dependency information, and the fourth processing rule may further include the intra-group dependency information.

FIG. 17 is a flowchart of a packet transmission method according to some embodiments. The method, as illustrated in FIG. 17, for example, may be performed by a PCO. As shown in FIG. 17, the method provided in some embodiments may include:

1710: Obtain external group identification information of a packet of a target service stream and inter-group external dependency information of the packet.

1720: Determine group identification information that is of a packet in a core network and that corresponds to the external group identification information, and inter-group dependency information that is of the packet in the core network and that corresponds to the inter-group external dependency information.

1730: Generate a second packet processing policy rule, the second packet processing policy rule including the external group identification information, the group identification information corresponding to the external group identification information, the inter-group external dependency information, and the inter-group dependency information corresponding to the inter-group external dependency information.

1740: Send the second packet processing policy rule to an SMO.

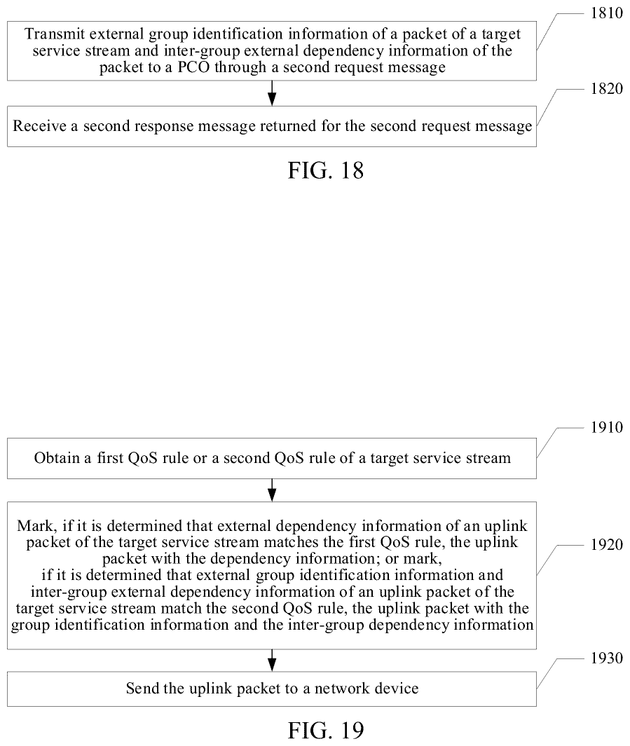

FIG. 18 is a flowchart of a packet transmission method according to some embodiments. The method, as illustrated in FIG. 18, for example, may be performed by an AO. As shown in FIG. 18, the method provided in some embodiments may include:

1810: Transmit external group identification information of a packet of a target service stream and inter-group external dependency information of the packet to a PCO through a second request message.

1820: Receive a second response message returned for the second request message.

The second request message may be configured for instructing the PCO to determine group identification information that is of a packet in a core network and that corresponds to the external group identification information and inter-group dependency information that is of the packet in the core network and that corresponds to the inter-group external dependency information, and generate a second packet processing policy rule, and the second packet processing policy rule may include the external group identification information, the group identification information corresponding to the external group identification information, the inter-group external dependency information, and the inter-group dependency information corresponding to the inter-group external dependency information.

Further, some embodiments further provide a packet transmission method. The method may be performed by a UPO (which may be an anchor UPO or an intermediate UPO), and the method may include: obtaining a second detection rule and a second processing rule of a target service stream from an SMO, and the second detection rule may include group identification information of a packet in a core network of the target service stream and inter-group dependency information in the core network; receiving a to-be-forwarded packet; and processing the to-be-forwarded packet according to the second detection rule and the second processing rule.

FIG. 19 is a flowchart of a packet transmission method according to some embodiments. The method, as illustrated in FIG. 19, for example, may be performed by a terminal.

As shown in FIG. 19, the method provided in some embodiments may include:

1910: Obtain a first QoS rule or a second QoS rule of a target service stream, and the first QoS rule may include external dependency information of a packet of the target service stream and dependency information that is of a packet in a core network and that corresponds to the external dependency information; and the second QoS rule may include external group identification information of the packet of the target service stream, group identification information that is of a packet in a core network and that corresponds to the external group identification information, inter-group external dependency information of the packet of the target service stream, and inter-group dependency information that is of the packet in the core network and that corresponds to the inter-group external dependency information.

1920: Mark, if it is determined that external dependency information of an uplink packet of the target service stream satisfies the first QoS rule, the uplink packet with the dependency information; or mark, if it is determined that external group identification information and inter-group external dependency information of an uplink packet of the target service stream satisfy the second QoS rule, the uplink packet with the group identification information and the inter-group dependency information.

1930: Send the uplink packet to a network device.

In some embodiments, network transmission for a packet such as a media packet is optimized. Based on a group of packets having a close dependence relationship, if a packet in the group is lost for a reason such as congestion, the network may consider to determine, according to characteristics of the packets, a packet which is lost, thereby reducing the impact on decoding on the client or server side, which may ensure service experience of a target service such as a multimedia service as much as possible.

Further, some embodiments provide a packet transmission method. The method may be performed by an anchor UPO, and the method may include: obtaining a third detection rule and a third processing rule of a target service stream, and the third detection rule may include external dependency information of a packet of the target service stream, and the third processing rule may include dependency information that is of a packet in a core network and that corresponds to the external dependency information; marking, if it is determined that external dependency information of a downlink packet of the target service stream satisfies the third detection rule, the downlink packet with the dependency information in the third processing rule; and sending the downlink packet that is encapsulated and that is marked with the dependency information to a network device.

Some embodiments provide a packet transmission method, The method may be performed by an anchor UPO, and the method may include: obtaining a fourth detection rule and a fourth processing rule of a target service stream, and the fourth detection rule may include external group identification information of a packet of the target service stream and inter-group external dependency information of the packet of the target service stream, and the fourth processing rule may include group identification information that is of a packet in a core network and that corresponds to the external group identification information, and inter-group dependency information that is of the packet in the core network and that corresponds to the inter-group external dependency information; marking, if it is determined that external group identification information and inter-group external dependency information of a downlink packet of the target service stream satisfies the fourth detection rule, the downlink packet with the corresponding group identification information and the corresponding inter-group dependency information corresponding in the fourth processing rule; and sending the downlink packet that is encapsulated and that is marked with the group identification information and the inter-group dependency information to a network device.

Further, some embodiments provide a packet transmission method. The packet transmission method may be performed by an AO, and the method may include: transmitting an updated frame rate parameter of a target service stream to a PCO, the updated frame rate parameter being configured for instructing the PCO to generate a network configuration policy rule and send the network policy configuration policy rule to an SMO, and the network configuration policy rule including the updated frame rate parameter; the network configuration policy rule being configured for instructing the SMO to send the updated frame rate parameter to a network device; and the updated frame rate parameter being configured for instructing the network device to update network parameter configuration information of the network device and a terminal according to the updated frame rate parameter.

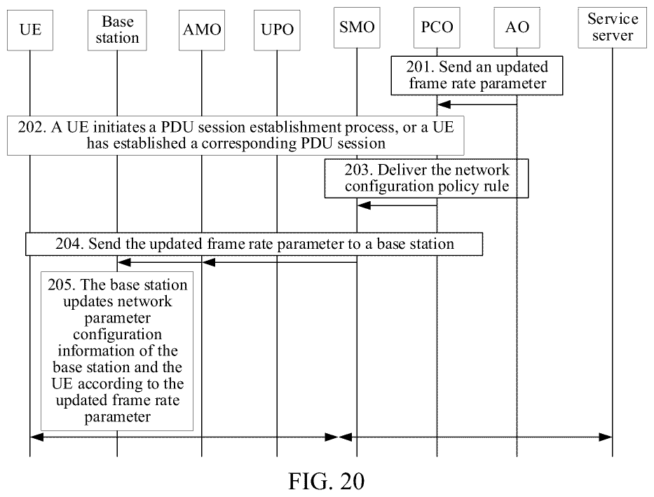

As shown in FIG. 20, the method may include the following operations.

201: An AO may send an updated frame rate parameter to a PCO.

202: A UE initiates a PDU session establishment process, or a UE has established a corresponding PDU session.

203: The PCO receives the updated frame rate parameter sent by the AO; and may generate a network configuration policy rule according to the updated frame rate parameter, and deliver the network configuration policy rule to an SMO.

204: Based on receiving the network configuration policy rule delivered by the PCO, the SMO may send the updated frame rate parameter carried in the network configuration policy rule to a base station through an AMO.

205: Based on receiving the updated frame rate parameter, the base station may update network parameter configuration information of the base station and the UE according to the updated frame rate parameter.

In some embodiments, given that periodicity of a service may affect the parameter configuration of the base station and this periodicity may be changing, the AO may send the updated frame rate parameter to the network based on the periodicity of the service, for example, a frame rate changing, to cause the network to adjust corresponding network parameter configuration information.

Some embodiments provide a network device, which may include a receiving unit and a processing unit.

The receiving unit may be configured to obtain first QoS profile information of a target service stream from an SMO, and the first QoS profile information may include a first detection rule and a first processing rule, and the first detection rule may include dependency information of a packet in a core network.

The receiving unit may be further configured to receive a to-be-forwarded packet.

The processing unit may be configured to process the to-be-forwarded packet according to the first detection rule and the first processing rule in the first QoS profile information.

In some embodiments, the processing unit may be further configured to: based on congestion occurring in a network, transmit the to-be-forwarded packet according to the first processing rule if it is determined that dependency information of the to-be-forwarded packet satisfies the first detection rule; or discard the to-be-forwarded packet according to the first processing rule if dependency information of the to-be-forwarded packet does not satisfy the first detection rule.

In some embodiments, the first detection rule may further include data group dependency information.

Further, Some embodiments further provide a UPO, which may include: a receiving unit, which may be configured to obtain a first detection rule and a first processing rule of a target service stream from an SMO, and the first detection rule may include dependency information of a packet in a core network; the receiving unit may be further configured to receive a to-be-forwarded packet; and a processing unit, which may be configured to process the to-be-forwarded packet according to the first detection rule and the first processing rule.

Some embodiments provide a network device, which may include a receiving unit and a processing unit.

The receiving unit may be configured to obtain second QoS profile information of a target service stream from an SMO, and the second QoS profile information may include a second detection rule and a second processing rule, and the second detection rule may include group identification information of a packet in a core network of the target service stream and inter-group dependency information in the core network.

The receiving unit may be further configured to receive a to-be-forwarded packet.

The processing unit may be configured to process the to-be-forwarded packet according to the second detection rule and the second processing rule in the second QoS profile information.

In some embodiments, the processing unit may be further configured to: based on congestion occurring in a network, transmit the to-be-forwarded packet according to the second processing rule if it is determined that group identification information and inter-group dependency information of the to-be-forwarded packet satisfy the second detection rule; or discard the to-be-forwarded packet according to the second processing rule if it is determined that group identification information of the to-be-forwarded packet satisfies the second detection rule and inter-group dependency information of the to-be-forwarded packet does not satisfy the second detection rule.

In some embodiments, the second detection rule may further include intra-group dependency information in the core network. The processing unit may be further configured to transmit the to-be-forwarded packet according to the second processing rule if it is determined that the group identification information, the inter-group dependency information, and intra-group dependency information of the to-be-forwarded packet satisfy the second detection rule.

Further, some embodiments further provide a UPO, which may include: a receiving unit, which may be configured to obtain a second detection rule and a second processing rule of a target service stream from an SMO, and the second detection rule may include group identification information of a packet in a core network of the target service stream and inter-group dependency information in the core network; the receiving unit may be further configured to receive a to-be-forwarded packet; and a processing unit, which may be configured to process the to-be-forwarded packet according to the second detection rule and the second processing rule.

Some embodiments provide an SMO, which may include a receiving unit, a processing unit, and a sending unit.

The receiving unit may be configured to obtain a first packet processing policy rule from a PCO, and the first packet processing policy rule may include external dependency information of a packet of a target service stream and dependency information that is of a packet in a core network and that corresponds to the external dependency information.

The processing unit may be configured to generate first QoS profile information of the target service stream, a third detection rule, a third processing rule, and a first QoS rule according to the first packet processing policy rule, and the first QoS profile information may include a first detection rule and a first processing rule, the first detection rule may include the dependency information, the third detection rule may include the external dependency information, the third processing rule may include the dependency information, and the first QoS rule may include the external dependency information and the dependency information corresponding to the external dependency information.

The sending unit may be configured to send the first QoS profile information to a network device, send the third detection rule and the third processing rule to an anchor UPO, and send the first QoS rule to a terminal.

Some embodiments provide an SMO, which may include a receiving unit, a processing unit, and a sending unit.

The receiving unit may be configured to obtain a second packet processing policy rule from a PCO, the second packet processing policy rule including external group identification information of a packet of a target service stream, group identification information that is of a packet in a core network and that corresponds to the external group identification information, inter-group external dependency information of the packet, and inter-group dependency information that is of the packet in the core network and that corresponds to the inter-group external dependency information.

The processing unit may be configured to generate second QoS profile information of the target service stream, a fourth detection rule, a fourth processing rule, and a second QoS rule according to the second packet processing policy rule, and the second QoS profile information may include a second detection rule and a second processing rule, the second detection rule may include the group identification information and the inter-group dependency information, the fourth detection rule includes the external group identification information and the inter-group external dependency information, the fourth processing rule may include the group identification information and the inter-group dependency information, and the second QoS rule may include the external group identification information, the group identification information corresponding to the external group identification information, the inter-group external dependency information, and the inter-group dependency information corresponding to the inter-group external dependency information.

The sending unit may be configured to send the second QoS profile information to a network device, send the fourth detection rule and the fourth processing rule to an anchor UPO, and send the second QoS rule to a terminal.

Some embodiments provide a PCO, which may include: a receiving unit, which may be configured to obtain external dependency information of a packet of a target service stream; a processing unit, which may be configured to determine dependency information that is of a packet in a core network and that corresponds to the external dependency information; the processing unit may be further configured to generate a first packet processing policy rule according to the dependency information, and the first packet processing policy rule may include the external dependency information and the dependency information corresponding to the external dependency information; and a sending unit, which may be configured to send the first packet processing policy rule to an SMO.

Some embodiments provide a PCO, which may include: a receiving unit, which may be configured to obtain external group identification information of a packet of a target service stream and inter-group external dependency information of the packet; a processing unit, which may be configured to determine group identification information that is of a packet in a core network and that corresponds to the external group identification information, and inter-group dependency information that is of the packet in the core network and that corresponds to the inter-group external dependency information; the processing unit may be further configured to generate a second packet processing policy rule, the second packet processing policy rule including the external group identification information, the group identification information corresponding to the external group identification information, the inter-group external dependency information, and the inter-group dependency information corresponding to the inter-group external dependency information; and a sending unit, which may be configured to send the second packet processing policy rule to an SMO.

Some embodiments provide an AO, which may include: a sending unit, which may be configured to transmit external dependency information of a packet of a target service stream to a PCO through a first request message; and a receiving unit, which may be configured to receive a first response message returned for the first request message, and the first request message may be configured for instructing the PCO to determine dependency information of a packet in a core network corresponding to the external dependency information according to the external dependency information, and generate a first packet processing policy rule, and the first packet processing policy rule may include the external dependency information and the dependency information.

Some embodiments provide an AO, including: a sending unit, which may be configured to transmit external group identification information of a packet of a target service stream and inter-group external dependency information of the packet to a PCO through a second request message; and a receiving unit, which may be configured to receive a second response message returned for the second request message, and the second request message may be configured for instructing the PCO to determine group identification information that is of a packet in a core network and that corresponds to the external group identification information and inter-group dependency information that is of the packet in the core network and that corresponds to the inter-group external dependency information, and generate a second packet processing policy rule, and the second packet processing policy rule may include the external group identification information, the group identification information corresponding to the external group identification information, the inter-group external dependency information, and the inter-group dependency information corresponding to the inter-group external dependency information.

Some embodiments provide a terminal, which may include: a receiving unit, which may be configured to obtain a first QoS rule or a second QoS rule of a target service stream, and the first QoS rule may include external dependency information of a packet of the target service stream and dependency information that is of a packet in a core network and that corresponds to the external dependency information; and the second QoS rule may include external group identification information of the packet of the target service stream, group identification information that is of a packet in a core network and that corresponds to the external group identification information, inter-group external dependency information of the packet of the target service stream, and inter-group dependency information that is of the packet in the core network and that corresponds to the inter-group external dependency information; and a processing unit, which may be configured to: mark, if it is determined that external dependency information of an uplink packet of the target service stream satisfies the first QoS rule, the uplink packet with the dependency information; or mark, if it is determined that external group identification information and inter-group external dependency information of an uplink packet of the target service stream satisfy the second QoS rule, the uplink packet with the group identification information and the inter-group dependency information; and a sending unit, configured to send the uplink packet to a network device.

Further, Some embodiments provide an anchor UPO, which may include: a receiving unit, which may be configured to obtain a third detection rule and a third processing rule of a target service stream, and the third detection rule may include external dependency information of a packet of the target service stream, and the third processing rule may include dependency information that is of a packet in a core network and that corresponds to the external dependency information; a processing unit, which may be configured to mark, if it is determined that external dependency information of a downlink packet of the target service stream satisfies the third detection rule, the downlink packet with the dependency information in the third processing rule; and a sending unit, which may be configured to send the downlink packet that is encapsulated and that is marked with the dependency information to a network device.

Some embodiments provide an anchor UPO, which may include: a receiving unit, which may be configured to obtain a fourth detection rule and a fourth processing rule of a target service stream, and the fourth detection rule may include external group identification information of a packet of the target service stream and inter-group external dependency information of the packet of the target service stream, and the fourth processing rule may include group identification information that is of a packet in a core network and that corresponds to the external group identification information, and inter-group dependency information that is of the packet in the core network and that corresponds to the inter-group external dependency information; a processing unit, which may be configured to mark, if it is determined that external group identification information and inter-group external dependency information of a downlink packet of the target service stream satisfy the fourth detection rule, the downlink packet with the corresponding group identification information and the corresponding inter-group dependency information corresponding in the fourth processing rule; and a sending unit, which may be configured to send the downlink packet that is encapsulated and that is marked with the group identification information and the inter-group dependency information to a network device.

Some embodiments provide an AO, which may include: a sending unit, which may be configured to transmit an updated frame rate parameter of a target service stream to a PCO, and the updated frame rate parameter may be configured for instructing the PCO to generate a network configuration policy rule and send the network policy configuration policy rule to an SMO, and the network configuration policy rule may include the updated frame rate parameter; the network configuration policy rule may be configured for instructing the SMO to send the updated frame rate parameter to a network device; and the updated frame rate parameter may be configured for instructing the network device to update network parameter configuration information of the network device and a terminal according to the updated frame rate parameter.

According to some embodiments, each module or unit may exist respectively or be combined into one or more units. Some modules or units may be further split into multiple smaller function subunits, thereby implementing the same operations without affecting the technical effects of some embodiments. The modules or units are divided based on logical functions. In actual applications, a function of one module or unit may be realized by multiple units, or functions of multiple modules or units may be realized by one unit. In some embodiments, other modules or units be further included. In actual applications, these functions may also be realized cooperatively by the other modules or units, and may be realized cooperatively by multiple modules or units.

A person skilled in the art would understand that these “modules” or “units” could be implemented by hardware logic, a processor or processors executing computer software code, or a combination of both. The modules or units may also be implemented in software stored in a memory of a computer or a non-transitory computer-readable medium, and the instructions of each unit are executable by a processor to thereby cause the processor to perform the respective operations of the corresponding unit.

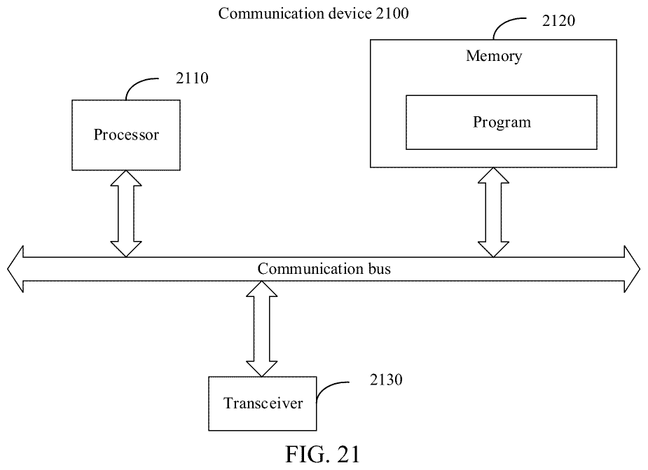

FIG. 21 is a schematic structural diagram of a communication device 2100 according to some embodiments. The communication device may be a terminal, for example, a UE, or may be a network device, for example, a base station, or may be a PCO and/or an NEO and/or an AO and/or an AMO and/or an SMO and/or a UPO. The communication device 2100 shown in FIG. 21 includes a processor 2110. The processor 2110 may invoke a computer program from a memory and run the computer program, to implement the method according to some embodiments.

In some embodiments, as shown in FIG. 21, the communication device 2100 may further include a memory 2120. The processor 2110 may invoke the computer program from the memory 2120 and run the computer program, to implement the method according to some embodiments.

The memory 2120 may be a component independent of the processor 2110, or may be integrated into the processor 2110.

In some embodiments, as shown in FIG. 21, the communication device 2100 may further include a transceiver 2130, and the processor 2110 may control the transceiver 2130 to communicate with another device and may send information or data to another device or receive information or data sent by another device.

The transceiver 2130 may include a transmitter and a receiver. The transceiver 2130 may further include an antenna, and a quantity of the antenna may be one or more.

In some embodiments, the communication device 2100 may be various network elements, and the communication device 2100 may implement corresponding procedures implemented by the network elements in various methods according to some embodiments.

In some embodiments, the communication device 2100 may be a network device, and the communication device 2100 may implement corresponding procedures implemented by the network device in various methods according to some embodiments.

In some embodiments, the communication device 2100 may be a mobile terminal/a terminal, and the communication device 2100 may implement corresponding procedures implemented by the mobile terminal/the terminal in various methods according to some embodiments.

The processor in some embodiments may be an integrated circuit chip having a signal processing capability. Operations in the method, according to some embodiments, may be implemented by using a hardware integrated logical circuit in the processor, or by using instructions in a form of software.

The processor may implement or perform the methods, the operations, and logical block diagrams of some embodiments. Operations of the method according to some embodiments may be directly implemented by a hardware decoding processor, or implemented by a combination of hardware in the decoding processor and a software module. The software module may be located in a mature storage medium in the art, such as a random access memory, a flash memory, a read-only memory, a programmable read-only memory, an electrically-erasable programmable memory, or a register. The storage medium is located in the memory. The processor reads information in the memory and completes the operations of the methods in combination with hardware thereof.

Some embodiments further provide a computer-readable storage medium, configured to store a computer program.

In some embodiments, the computer-readable storage medium may be applied to the network device, and the computer program enables a computer to perform corresponding procedures implemented by the network device in the methods in some embodiments.

In some embodiments, the computer-readable storage medium may be applied to the network elements, and the computer storage medium causes the computer to perform corresponding procedures implemented by the network elements in various methods according to some embodiments.

In some embodiments, the computer-readable storage medium may be applied to the network device in the mobile terminal/the terminal, and the computer program enables a computer to perform corresponding procedures implemented by the mobile terminal/the terminal in the methods in some embodiments.

Some embodiments further provide a computer program product, including a computer program instruction.

In some embodiments, the computer program product may be applied to the network device, and the computer program instruction enables a computer to perform corresponding procedures implemented by the network device in the methods in some embodiments.

In some embodiments, the computer program product may be applied to the network elements, and the computer program instruction causes the computer to perform corresponding procedures implemented by the network elements in various methods according to some embodiments.

In some embodiments, the computer program product may be applied to the mobile terminal/the terminal, and the computer program instruction enables a computer to perform corresponding procedures implemented by the mobile terminal/the terminal in the methods in some embodiments.

Some embodiments further provide a computer program.

In some embodiments, the computer program may be applied to the network device, and when the computer program is run on the computer, the computer is enabled to perform corresponding procedures implemented by the network device in the methods in some embodiments.

In some embodiments, the computer program may be applied to the network elements, and when the computer program is run on the computer, the computer is enabled to perform corresponding procedures implemented by the network elements in the methods in some embodiments.

In some embodiments, the computer program may be applied to the network device in the mobile terminal/the terminal, and when the computer program is run on the computer, the computer is enabled to perform corresponding procedures implemented by the mobile terminal/the terminal in the methods in some embodiments.

The foregoing embodiments are used for describing, instead of limiting the technical solutions of the disclosure. A person of ordinary skill in the art shall understand that although the disclosure has been described in detail with reference to some embodiments, modifications can be made to the technical solutions described in some embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A packet transmission method, performed by a network device, the method comprising:
obtaining quality of service (QOS) profile information of a target service stream from a session management object (SMO);
receiving a first packet to be forwarded; and
processing the first packet according to a detection rule of the QoS profile information and a processing rule of the QoS profile information,
wherein the detection rule includes second dependency information of a second packet of a core network.

2. The method according to claim 1, wherein the processing the first packet comprises:
based on congestion occurring in the first network,
transmitting the first packet according to the processing rule based on first dependency information of the first packet satisfying the detection rule; or
discarding the first packet according to the processing rule based on the first dependency information not satisfying the detection rule.

3. The method according to claim 1, wherein the second dependency information includes identification information based on a policy control object (PCO), and
wherein the second dependency information indicates whether an interdependency exists between different packets.

4. The method according to claim 1, wherein the detection rule includes second group identification information of the second packet and second inter-group dependency information of the second packet.

5. The method according to claim 4, wherein the processing the first packet comprises:
based on congestion occurring in the first network,
transmitting the first packet according to the processing rule based on first group identification information of the first packet and first inter-group dependency information of the first packet satisfying the detection rule; or
discarding the first packet according to the processing rule based on the first group identification information satisfying the detection rule and the first inter-group dependency information not satisfying the detection rule.

6. The method according to claim 5, wherein the detection rule further includes intra-group dependency information of the second packet, and
wherein the transmitting the first packet comprises transmitting the first packet according to the processing rule based on the first group identification information, the first inter-group dependency information, and first intra-group dependency information of the first packet satisfying the detection rule.

7. The method according to claim 4, wherein the detection rule further includes data group dependency information indicating packets of a group corresponding to the second group identification information are grouped according to a dependence relationship between the packets.

8. A communication device, comprising:
at least one memory configured to store computer program code;
at least one processor configured to read the program code and operate as instructed by the program code, the program code comprising:
obtaining code configured to cause at least one of the at least one processor to obtain quality of service (QOS) profile information of a target service stream from a session management object (SMO);
receiving code configured to cause at least one of the at least one processor to receive a first packet to be forwarded; and
processing code configured to cause at least one of the at least one processor to process the first packet according to a detection rule of the QoS profile information and a processing rule of the QoS profile information,
wherein the detection rule comprises second dependency information of a second packet of a core network.

9. The communication device accordance to claim 8, wherein the processing code is configured to cause at least one of the at least one processor to:
based on congestion occurring in the first network,
transmit the first packet according to the processing rule based on first dependency information of the first packet satisfying the detection rule; or
discard the first packet according to the processing rule based on the first dependency information not satisfying the detection rule.

10. The communication device accordance to claim 8, wherein the second dependency information comprises identification information based on a policy control object (PCO), and
wherein the second dependency information indicates whether an interdependency exists between different packets.

11. The communication device accordance to claim 8, wherein the detection rule comprises second group identification information of the second packet and second inter-group dependency information of the second packet.

12. The communication device according to claim 11, wherein the processing code is configured to cause at least one of the at least one processor to:
based on congestion occurring in the first network,
transmit the first packet according to the processing rule based on first group identification information of the first packet and first inter-group dependency information of the first packet satisfying the detection rule; or
discard the first packet according to the processing rule based on the first group identification information satisfying the detection rule and the first inter-group dependency information not satisfying the detection rule.

13. The communication device according to claim 12, wherein the detection rule further comprises intra-group dependency information of the second packet, and
wherein the processing code is configured to cause at least one of the at least one processor to, based on congestion occurring in the first network, transmit the first packet according to the processing rule based on the first group identification information, the first inter-group dependency information, and first intra-group dependency information of the first packet satisfying the detection rule.

14. The communication device according to claim 11, wherein the detection rule further comprises data group dependency information indicating packets of a group corresponding to the second group identification information are grouped according to a dependence relationship between the packets.

15. A non-transitory computer-readable storage medium, storing computer code which, when executed by at least one processor, causes the at least one processor to at least:
obtain quality of service (QOS) profile information of a target service stream from a session management object (SMO);
receive a first packet to be forwarded; and
process the first packet according to a detection rule of the QoS profile information and a processing rule of the QoS profile information,
wherein the detection rule comprises second dependency information of a second packet of a core network.

16. The non-transitory computer-readable storage medium according to claim 15, wherein the processing the first packet comprises:
based on congestion occurring in the first network,
transmitting the first packet according to the processing rule based on first dependency information of the first packet satisfying the detection rule; or
discarding the first packet according to the processing rule based on the first dependency information not satisfying the detection rule.

17. The non-transitory computer-readable storage medium according to claim 15, wherein the processing the first packet comprises: wherein the second dependency information includes identification information based on a policy control object (PCO), and
wherein the second dependency information indicates whether an interdependency exists between different packets.

18. The non-transitory computer-readable storage medium according to claim 15, wherein the detection rule includes second group identification information of the second packet and second inter-group dependency information of the second packet.

19. The non-transitory computer-readable storage medium according to claim 18, wherein the processing the first packet comprises:
based on congestion occurring in the first network,
transmitting the first packet according to the processing rule based on first group identification information of the first packet and first inter-group dependency information of the first packet satisfying the detection rule; or
discarding the first packet according to the processing rule based on the first group identification information satisfying the detection rule and the first inter-group dependency information not satisfying the detection rule.

20. The non-transitory computer-readable storage medium according to claim 19, wherein the detection rule further includes intra-group dependency information of the second packet, and
wherein the transmitting the first packet comprises transmitting the first packet according to the processing rule based on the first group identification information, the first inter-group dependency information, and first intra-group dependency information of the first packet satisfying the detection rule.
